(19) United States
(12) Patent Application Publication
(10) Pub. No.: US 2025/0183793 A1
(43) Pub. Date: Jun. 5, 2025

(54) METHOD FOR PWM SWITCHING OF ALTERNATING CURRENT VOLTAGE, AND HOUSEHOLD APPLIANCE IN WHICH METHOD IS EMPLOYED

(71) Applicant: SAMSUNG ELECTRONICS CO., LTD., Suwon-si (KR)

(72) Inventors: Hyomin AHN, Suwon-si (KR); Junseok Kim, Suwon-si (KR); Jehyung Cho, Suwon-si (KR); Hyowon Sin, Suwon-si (KR)

(73) Assignee: SAMSUNG ELECTRONICS CO., LTD., Suwon-si (KR)

(21) Appl. No.: 19/050,843

(22) Filed: Feb. 11, 2025

Related U.S. Application Data
(63) Continuation of application No. PCT/KR2023/012510, filed on Aug. 23, 2023.

(30) Foreign Application Priority Data
Sep. 14, 2022 (KR) 10-2022-0115843
Feb. 1, 2023 (KR) 10-2023-0013891

(51) Int. Cl. H02M 1/42; H02M 1/12; H02M 7/217

(52) U.S. Cl. CPC H02M 1/4208; H02M 1/12; H02M 7/217

(57) ABSTRACT

An appliance includes an input voltage sensor a power conversion device. The power conversion device detects a first predetermined point in time at which the input voltage sensed by the input voltage sensor approaches zero from negative, controls only the first upper switch to be switched during a first period from the first predetermined point in time to a point in time at which the sensed input voltage reaches zero, detects a second predetermined point in time at which the input voltage sensed by the input voltage sensor rises from zero to positive, and controls only the first lower switch to be switched during a second period from the point in time at which the sensed input voltage reaches zero to the second predetermined point in time.

### CROSS REFERENCE TO RELATED APPLICATIONS

This application is a bypass continuation application of International Application No. PCT/KR2023/012510, filed on Aug. 23, 2023, which is based on and claims priority to Korean Patent Application No. 10-2022-0115843, filed on Sep. 14, 2022, in the Korean Intellectual Property Office, and Korean Patent Application No. 10-2023-0013891, filed on Feb. 1, 2023, in the Korean Intellectual Property Office, the disclosures of which are incorporated by reference herein in their entireties.

### BACKGROUND

### 1. Field

The disclosure relates to a method of smoothly performing pulse width modulation (PWM) switching at zero crossing of an input voltage in a bridgeless power factor correction (PFC) converter, which is a type of PFC circuit that performs digital control, and a bridgeless PFC power conversion device employing the method. In addition, the disclosure relates to a household appliance using a bridgeless PFC power conversion device that employs a method of performing PWM switching at zero crossing of an input voltage.

### 2. Description of Related Art

In all electrical devices including household appliances, reducing power loss and optimizing power efficiency is advantageous in terms of power usage. In addition, electrical devices such as power conversion devices are driven at a high switching frequency. Power conversion devices perform PWM switching, but because the power conversion devices do not accurately determine the zero crossing of an input voltage, the power conversion devices omit PWM switching near the zero crossing, which increases harmonics and causes current spikes.

### SUMMARY

In accordance with an aspect of the disclosure, there is provided an appliance including: an input voltage sensor configured to sense an input voltage; a first leg including a first upper switch and a first lower switch; and a power conversion device including: memory storing instructions; and at least one processor, wherein the instructions, when executed by the at least one processor, cause the power conversion device to: detect a first predetermined point in time at which the input voltage sensed by the input voltage sensor approaches zero from negative; control only the first upper switch to be switched during a first period from the first predetermined point in time to a point in time at which the sensed input voltage reaches zero; detect a second predetermined point in time at which the input voltage sensed by the input voltage sensor rises from zero to positive; and control only the first lower switch to be switched during a second period from the point in time at which the sensed input voltage reaches zero to the second predetermined point in time.

The instructions, when executed by the at least one processor, may cause the power conversion device to decrease an on-duty ratio of the first upper switch as the sensed input voltage approaches zero during the first period.

The instructions, when executed by the at least one processor, may cause the power conversion device to increase an on-duty ratio of the first lower switch as the sensed input voltage approaches the second predetermined point in time during the second period.

The appliance may include a diode leg including an upper diode and a lower diode, wherein the power conversion device may be a unidirectional totem pole power conversion device.

The appliance may include a second leg including a second upper switch and a second lower switch, wherein the power conversion device may be a bidirectional totem pole power conversion device.

Switching speeds of the first upper switch and the first lower switch of the first leg may be faster than switching speeds of the second upper switch and the second lower switch of the second leg.

According to an aspect of the disclosure, there is provided a method of switching an input voltage, in an appliance including an input voltage sensor, and a first leg including a first upper switch and a first lower switch, the method including: sensing, by the input voltage sensor, the input voltage; detecting a first predetermined point in time at which the input voltage sensed by the input voltage sensor approaches zero from negative; controlling only the first upper switch to be switched during a first period from the first predetermined point in time to a point in time at which the sensed input voltage reaches zero; detecting a second predetermined point in time at which the sensed input voltage rises from zero to positive; and controlling only the first lower switch to be switched during a second period from the point in time at which the sensed input voltage reaches zero to the second predetermined point in time.

The controlling of only the first upper switch of the first leg to be switched during the first period from the first predetermined point in time to the point in time at which the sensed input voltage reaches zero may include decreasing an on-duty ratio of the first upper switch as the sensed input voltage approaches zero during the first period.

The detecting of the second predetermined point in time at which the sensed input voltage may rise from zero to positive and the controlling of only the first lower switch of the first leg to be switched during the second period from the point in time at which the sensed input voltage reaches zero to the second predetermined point in time may include increasing an on-duty ratio of the first lower switch as the sensed input voltage approaches the second predetermined point in time during the second period.

The appliance may include a second leg including a second upper switch and a second lower switch, wherein the appliance includes a unidirectional totem pole power conversion device.

The appliance may include a second leg including a second upper switch and a second lower switch, and a bidirectional totem pole power conversion device.

Switching speeds of the first upper switch and the first lower switch of the first leg may be faster than switching speeds of the second upper switch and the second lower switch of the second leg.

According to an aspect of the disclosure, there is provided a power conversion device including: an input voltage sensor configured to sense an input voltage; a first leg including a first upper switch and a first lower switch; memory storing instructions; and at least one processor, wherein the instructions, when executed by the at least one processor, cause the power conversion device to: detect a first predetermined point in time at which the input voltage sensed by the input voltage sensor approaches zero from negative; control only the first upper switch to be switched during a first period from the first predetermined point in time to a point in time at which the sensed input voltage reaches zero; detect a second predetermined point in time at which the input voltage sensed by the input voltage sensor rises from zero to positive; and control only the first lower switch to be switched during a second period from the point in time at which the sensed input voltage reaches zero to the second predetermined point in time.

The instructions, when executed by the at least one processor, may cause the power conversion device to decrease an on-duty ratio of the first upper switch as the sensed input voltage approaches zero during the first period.

The instructions, when executed by the at least one processor, may cause the power conversion device to increase an on-duty ratio of the first lower switch as the sensed input voltage approaches the second predetermined point in time during the second period.

### BRIEF DESCRIPTION OF THE DRAWINGS

The above and other aspects and/or features of one or more embodiments of the present disclosure will be more apparent from the following description taken in conjunction with the accompanying drawings, in which:

FIG. 1 is a circuit diagram of a power conversion device including a power factor correction (PFC) circuit, according to an embodiment;

FIG. 2 is a diagram showing a bridgeless PFC power conversion device, according to an embodiment;

FIG. 3 is a diagram showing that a current spike occurs at a zero crossing point of an input voltage, according to an embodiment;

FIG. 4A is a circuit diagram including a detector for detecting the zero crossing of an input voltage in a unidirectional totem pole bridgeless PFC power conversion device according to an embodiment of the disclosure;

FIG. 4B is a circuit diagram including a detector for detecting the zero crossing of an input voltage in a bidirectional totem pole bridgeless PFC power conversion device according to an embodiment of the disclosure;

FIG. 4C is a circuit diagram including a detector for detecting the zero crossing of an input voltage in a semi-bridgeless PFC power conversion device according to an embodiment of the disclosure;

FIGS. 5A and 5B are waveform diagrams each comparing an actual input voltage with a sensed input voltage in a power conversion device;

FIG. 6A is a waveform diagram in which a non-switching period is near the zero crossing of an input voltage;

FIG. 6B is a waveform diagram showing PWM switching performed near the zero crossing of an input voltage in a power conversion device according to an embodiment of the disclosure;

FIGS. 7A and 7B are circuit diagrams each showing an operating switch and a current flow diagram under an abnormal condition in a Period 2 in a unidirectional totem pole power conversion device according to an embodiment of the disclosure;

FIGS. 8A and 8B are circuit diagrams each showing an operating switch and a current flow diagram under a normal condition in a Period 2 in a unidirectional totem pole power conversion device according to an embodiment of the disclosure;

FIGS. 9A and 9B are circuit diagrams each showing an operating switch and a current flow diagram under an abnormal condition in a Period 3 in a unidirectional totem pole power conversion device according to an embodiment of the disclosure;

FIGS. 10A and 10B are circuit diagrams each showing an operating switch and a current flow diagram under a normal condition in a Period 3 in a unidirectional totem pole power conversion device according to an embodiment of the disclosure;

FIGS. 11A and 11B are circuit diagrams each showing an operating switch and a current flow diagram under an abnormal condition in a Period 2 in a bidirectional totem pole power conversion device according to an embodiment of the disclosure;

FIGS. 12A and 12B are circuit diagrams each showing an operating switch and a current flow diagram under a normal condition in a Period 2 in a bidirectional totem pole power conversion device according to an embodiment of the disclosure;

FIGS. 13A and 13B are circuit diagrams each showing an operating switch and a current flow diagram under an abnormal condition in a Period 3 in a bidirectional totem pole power conversion device according to an embodiment of the disclosure;

FIGS. 14A and 14B are circuit diagrams each showing an operating switch and a current flow diagram under a normal condition in a Period 3 in a bidirectional totem pole power conversion device according to an embodiment of the disclosure;

FIGS. 15A and 15B are circuit diagrams each showing an operating switch and a current flow diagram under an abnormal condition in a Period 2 in a bidirectional totem pole power conversion device according to an embodiment of the disclosure;

FIGS. 16A and 16B are circuit diagrams each showing an operating switch and a current flow diagram under a normal condition in a Period 2 in a bidirectional totem pole power conversion device according to an embodiment of the disclosure;

FIGS. 17A and 17B are circuit diagrams each showing an operating switches and a current flow diagram under an abnormal condition in a Period 3 in a bidirectional totem pole power conversion device according to an embodiment of the disclosure;

FIGS. 18A and 18B are circuit diagrams each showing an operating switch and a current flow diagram under a normal condition in a Period 3 in a bidirectional totem pole power conversion device according to an embodiment of the disclosure;

FIGS. 19A and 19B are circuit diagrams each showing an operating switch and a current flow diagram under an abnormal condition in a Period 2 in a semi-bridgeless power conversion device according to an embodiment of the disclosure;

FIGS. 20A and 20B are circuit diagrams each showing an operating switch and a current flow diagram under a normal condition in a Period 2 in a semi-bridgeless power conversion device according to an embodiment of the disclosure;

FIGS. 21A and 21B are circuit diagrams each showing an operating switch and a current flow diagram under an abnormal condition in a Period 3 in a semi-bridgeless power conversion device according to an embodiment of the disclosure;

FIGS. 22A and 22B are circuit diagrams each showing an operating switch and a current flow diagram under a normal condition in a Period 3 in a semi-bridgeless power conversion device according to an embodiment of the disclosure;

FIG. 23A is a waveform diagram illustrating an input voltage and an input current when a non-switching period is set at zero crossing, according to an embodiment of the disclosure;

FIG. 23B is a waveform diagram illustrating an input voltage and an input current when only one switch is switched per period at zero crossing, according to an embodiment of the disclosure;

FIG. 24 is a diagram showing the size of a PWM switching period at zero crossing of an input voltage of a power conversion device, according to an embodiment of the disclosure;

FIG. 25 is a block diagram of a power conversion device according to an embodiment of the disclosure;

FIG. 26 is a flowchart of switching control at zero crossing of an input voltage in a power conversion device according to an embodiment of the disclosure;

FIG. 27 is a flowchart of switching control at zero crossing of an input voltage in a bidirectional totem pole power conversion device according to an embodiment of the disclosure;

FIG. 28 is a flowchart of switching control at zero crossing of an input voltage in a semi-bridgeless power conversion device according to an embodiment of the disclosure; and

FIG. 29 is a diagram illustrating various household appliances including a power conversion device according to an embodiment of the disclosure.

### DETAILED DESCRIPTION

In the disclosure, the expression “at least one of a, b or c” may refer to “a”, “b”, “c”, “a and b”, “a and c”, “b and c”, or “all of a, b and c.”

Terms used herein will be briefly described and then an embodiment of the disclosure will be described in detail.

The terms used herein are those general terms currently widely used in the art in consideration of functions in an embodiment of the disclosure, but the terms may vary according to the intentions of those of ordinary skill in the art, precedents, or new technology in the art. Also, in some cases, there may be terms that are optionally selected by the applicant, and the meanings thereof will be described in detail in the corresponding embodiment of the disclosure. Thus, the terms used herein should be understood not as simple names but based on the meanings of the terms and the overall description of the disclosure.

Throughout the disclosure, when something is referred to as “including” an element, one or more other elements may be further included unless specified otherwise. Also, as used herein, the terms such as “units” and “modules” may refer to units that perform at least one function or operation, and the units may be implemented as hardware or software or a combination of hardware and software.

Hereinafter, an embodiment of the disclosure will be described in detail with reference to the accompanying drawings so that those of ordinary skill in the art may easily implement the disclosure. However, an embodiment of the disclosure may be embodied in many different forms and should not be construed as being limited to the embodiments set forth herein. Also, portions irrelevant to the description of the disclosure will be omitted in the drawings for a clear description of an embodiment of the disclosure, and like reference numerals will denote like elements throughout the disclosure.

According to an embodiment of the disclosure, when an input voltage crosses zero in a power factor correction (PFC) power conversion device, it is related to continuous switching without a spike voltage or non-switching period. Usually, when the input voltage, which is an alternating current (AC) voltage, crosses zero in a bridgeless PFC power conversion device, unlike a typical boost PFC converter, a non-switching period is provided near the zero crossing. The reason is that it is difficult to confirm the point where the input voltage becomes exactly 0 due to various factors, such as delay according to a sensing circuit in an input voltage sensor, sensing noise, and analog-to-digital conversion delay (ADC delay). In addition, when the system incorrectly determines the zero crossing point of the input voltage, the polarity of an actual voltage and the polarity of a switching command voltage become different, resulting in spike current. In order to prevent such spike current, a separate algorithm or a high-precision sensor that precisely detects the non-switching period is used, but there is a limitation. Therefore, the PFC power conversion device generally performs PWM switching control that turns off all switches near the zero crossing, which not only reduces the power conversion efficiency but also increases the harmonics of the system.

Throughout the specification, the ‘PFC power conversion device’ may be briefly referred to as a ‘power factor correction power conversion device’, a ‘power control device’, or simply a ‘power conversion device’, and the ‘converter’ may be used with the same meaning as the ‘power conversion device’ or the ‘power control device’.

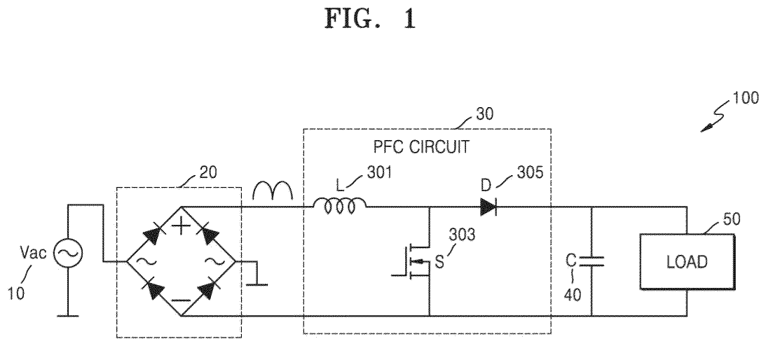

FIG. 1 is a circuit diagram of a power conversion device including a power factor correction (PFC) circuit.

FIG. 1 illustrates a power conversion device 100 including a PFC circuit. The power conversion device 100 including a PFC circuit according to FIG. 1 is a bridge-type power conversion device in which a rectifier 20 is composed of a diode. The power conversion device 100 includes an input voltage supplier 10, the rectifier 20, a PFC circuit 30, and a direct current (DC) link capacitor 40. The power conversion device 100 is connected to a load 50 and consumes power according to the load 50 while supporting the load 50. The PFC circuit 30 may include an inductor 301, a switch 303, and a diode 305.

When the power conversion device 100 is of a bridge type, the rectifier 20 is composed entirely of diodes. The switch 303 of the PFC circuit 30 may use an active switch element for voltage boosting. The switch 303 may be composed of an Insulated Gate Bipolar Transistor (IGBT), a transistor, or a Metal Oxide Semiconductor Field Effect Transistor (MOSFET), but is not limited thereto.

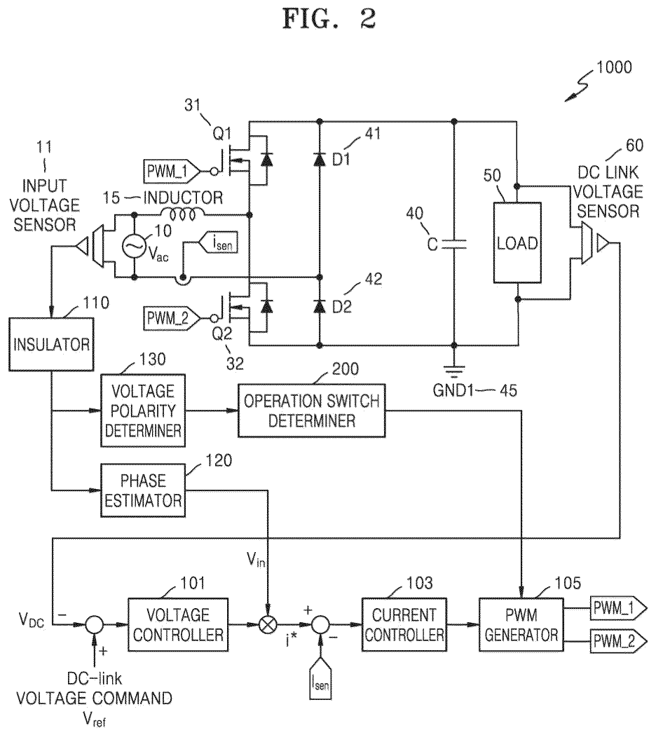

FIG. 2 is a diagram showing a bridgeless PFC power conversion device 1000.

In the bridge type, a PFC circuit is configured at the rear end of the rectifier 20, but in the bridgeless PFC power conversion device 1000 according to FIG. 2, an inductor 15 is connected to one end of an input voltage supplier 10, and switches Q1 (31) and Q2 (32) are provided instead of a rectifier diode in one leg corresponding to the rectifier 20 of FIG. 1 to enable voltage boosting across a DC link capacitor 40. Therefore, unlike in FIG. 1, where the PFC circuit 30 is located at the rear end of the rectifier 20, in the bridgeless PFC power conversion device 1000 according to FIG. 2, the rectifier is configured as a bridgeless circuit, and the switches Q1 (31) and Q2 (32) are placed instead of diodes included in the rectifier, thereby performing voltage boosting and PFC through a process of sending the energy stored in the inductor 15 at the front end to the DC link capacitor 40.

In FIG. 2, a voltage controller 101 and a current controller 103 may use a PI controller, but are not limited thereto, and a P controller or a PID controller may also be used.

Referring to FIG. 2, the difference between a voltage value V_{DC} sensed at both ends of the DC link capacitor 40 and a voltage command V_{ref} is input to the voltage controller 101, and then a control operation is performed. The output of the voltage controller 101 is multiplied by an input voltage Vᵢₙ detected by a phase estimator 120 to generate a current command i*, and the difference between the generated current command i* and a sensed input current Iₛₑₙ is input to the current controller 103, and then the current controller 103 outputs a switching command for the switches Q1 (31) and Q2 (32). A PWM generator 105 generates a PWM_1 signal applied to Q1 (31) and a PWM_2 signal applied to Q2 (32) according to the switching command. The PWM_1 and PWM_2 signals are Pulse Width Modulation (PWM) signals that are ultimately applied to the switch Q1 (31) and the switch Q2 (32), respectively, according to results of the controller operation.

In the bridgeless PFC power conversion device 1000, the voltage of the input voltage supplier 10 is sensed by an input voltage sensor 11, and based on the sensed voltage, a voltage polarity determiner 130 determines whether the voltage of the input voltage supplier 10 is a negative half-cycle or a positive half-cycle, and an operation switch determiner 200 determines an operation switch.

In FIG. 2, the operations of an insulator 110, the phase estimator 120, the voltage polarity determiner 130, the operation switch determiner 200, the voltage controller 101, the current controller 103, and the PWM generator 105 may be performed by a processor (not shown) of the bridgeless PFC power conversion device 1000.

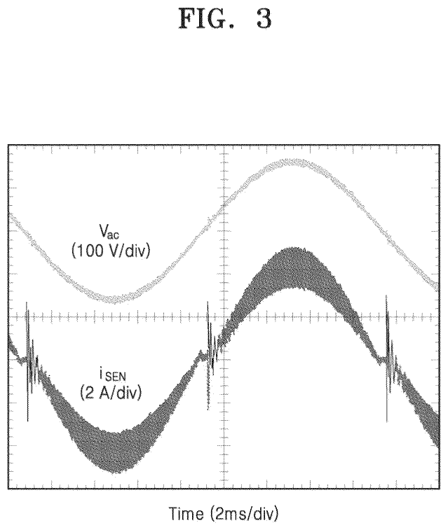

FIG. 3 is a diagram showing that a current spike occurs at a zero crossing point of an input voltage.

As shown in FIG. 3, when the zero crossing point of an input voltage V_{ac} (i.e., the voltage of the input voltage supplier 10) is incorrectly determined, a spike occurs in an input current i_{SEN}. Therefore, in order to prevent the spikes occurring in the input current i_{SEN}, a control unit of the system performs control by setting a period in which all switches are turned off near the zero crossing of the voltage of the input voltage supplier 10.

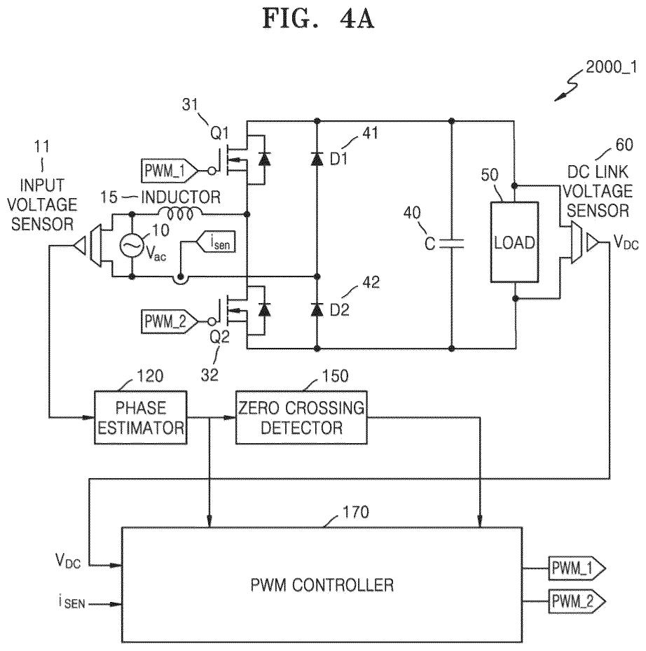

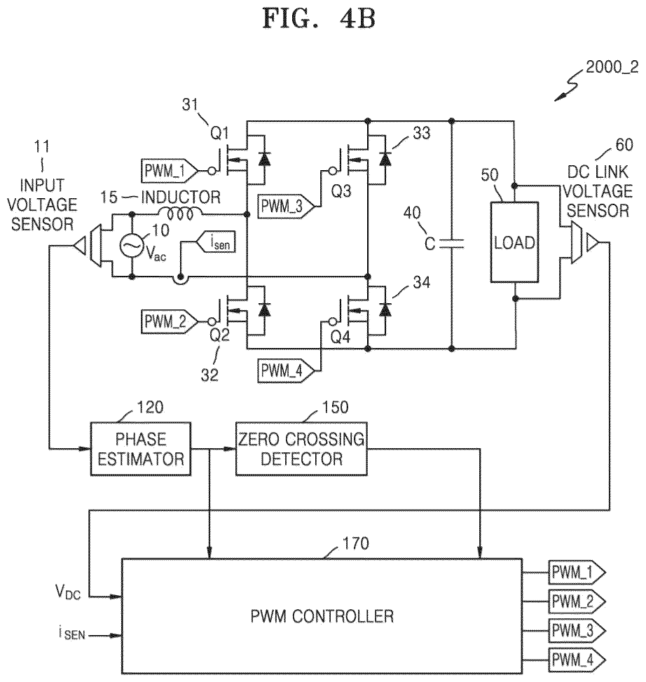

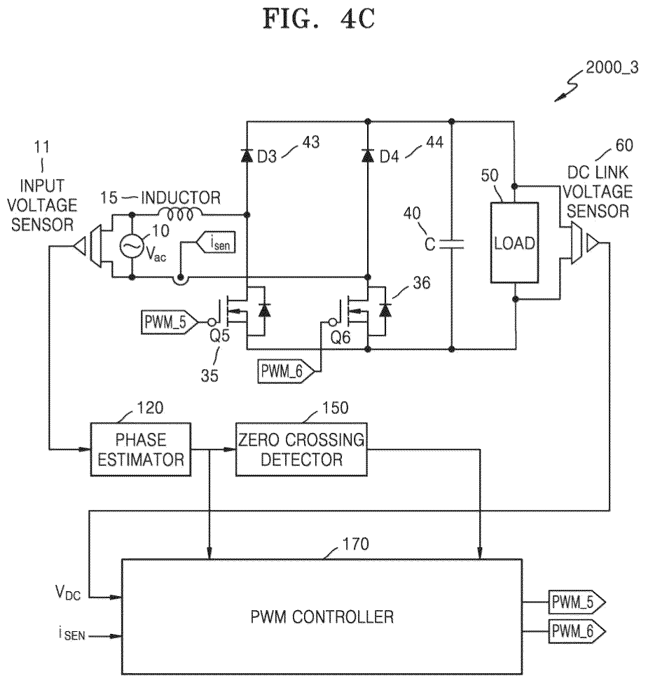

FIG. 4A is a circuit diagram including a detector for detecting the zero crossing of an input voltage in a unidirectional totem pole bridgeless PFC power conversion device according to an embodiment of the disclosure.

Throughout the specification, the unidirectional totem pole bridgeless PFC power conversion device is also referred to as a unidirectional totem pole power conversion device 2000_1.

Referring to FIG. 4A, an input voltage sensor 11 senses an voltage of the input voltage supplier 10, and the sensed voltage of the input voltage supplier 10 is transmitted to a phase estimator 120. The phase estimator 120 estimates the phase of the voltage of the input voltage supplier 10. The phase estimator 120 may obtain a voltage shape by using a Phase Locked Loop (PLL) or an Operational Amplifier (OP AMP) circuit as a method for obtaining the phase of a general AC input voltage. A seamless zero crossing detector proposed according to the disclosure may be applied to all phase estimators.

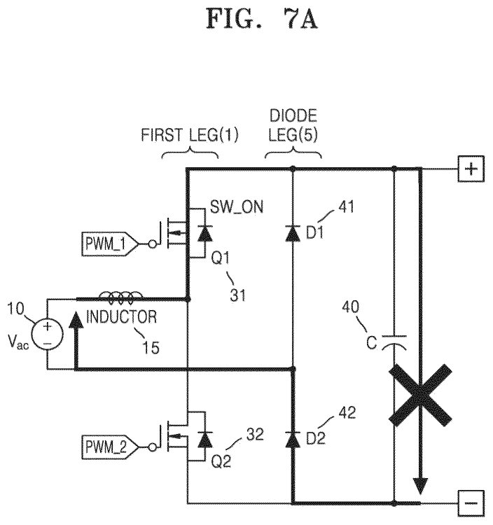

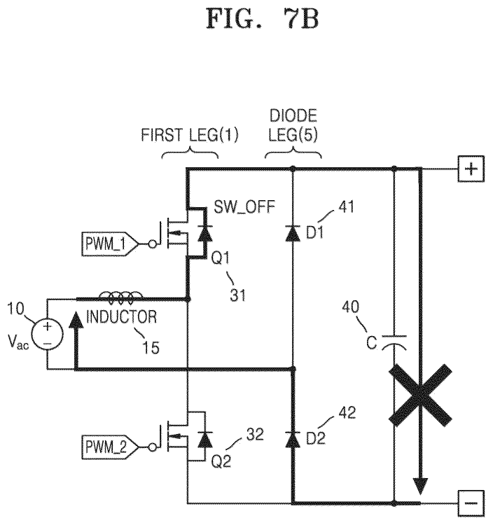

A zero crossing detector 150 detects the zero crossing of the voltage of the input voltage supplier 10 through the phase estimated by the phase estimator 120. According to an embodiment of the disclosure, the zero crossing detector 150 is a block that changes a main operation switch without providing a separate non-switching period near the zero crossing of the voltage of the input voltage supplier 10. The details of the main operation switch change are described with reference to FIGS. 7A to 10B below.

According to an embodiment, based on an estimated phase and a selected main operating switch, a PWM controller 170 outputs a PWM switching signal for switching Q1 (31) and Q2 (32) of the unidirectional totem pole power conversion device 2000_1 and transmits the PWM switching signal to the two switches.

The totem pole bridgeless PFC power conversion device 2000_1 according to FIG. 4A is a unidirectional totem pole power conversion device, and therefore has a configuration in which a first upper switch Q1 (31) and a first lower switch Q2 (32) are included in one leg and an upper diode D1 (41) and a lower diode D2 (42) are included in the other leg.

FIG. 4B is a circuit diagram including a detector for detecting the zero crossing of an input voltage in a bidirectional totem pole bridgeless PFC power conversion device according to an embodiment of the disclosure.

Throughout the specification, the bidirectional totem pole bridgeless PFC power conversion device is also referred to as a bidirectional totem pole power conversion device 2000_2.

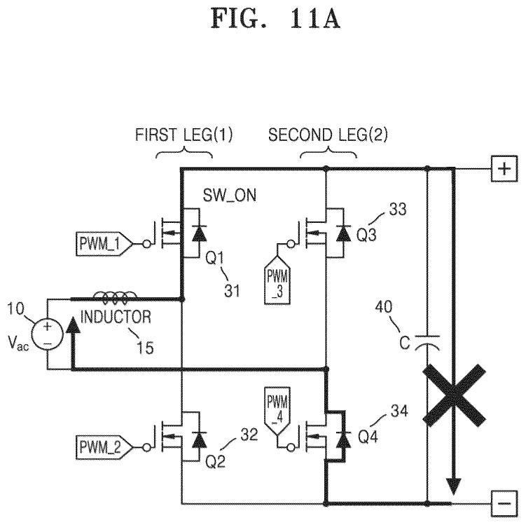

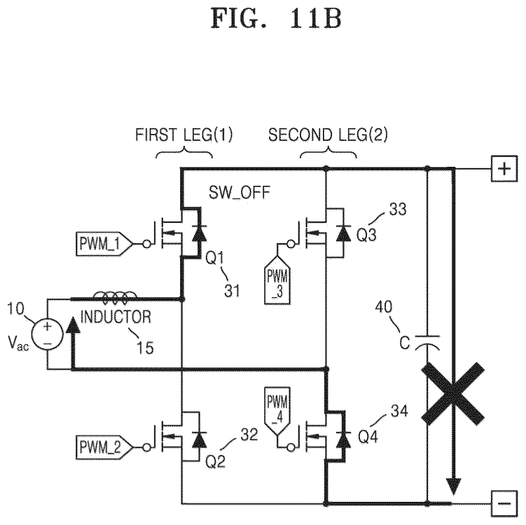

Referring to FIG. 4B, as in FIG. 4A, an input voltage sensor 11 senses an voltage of the input voltage supplier 10, and the sensed voltage of the input voltage supplier 10 is transmitted to a phase estimator 120. The phase estimator 120 estimates the phase of the voltage of the input voltage supplier 10, and a zero crossing detector 150 detects the zero crossing of the voltage of the input voltage supplier 10 through the estimated phase. According to an embodiment of the disclosure, the zero crossing detector 150 is a block that changes a main operation switch without providing a separate non-switching period near the zero crossing of the voltage of the input voltage supplier 10. The details of the main operation switch change are described with reference to FIGS. 11A to 14B below.

Through an estimated phase, a PWM controller 170 outputs PWM switching signals PWM_1, PWM_2, PWM_3, and PWM_4 for switching Q1 (31), Q2 (32), Q3 (33), and Q4 (34) of the bidirectional totem pole power conversion device 2000_2 and transmits the PWM switching signals to the four switches. The bidirectional totem pole power conversion device 2000_2 according to FIG. 4B has a configuration in which two switches, that is, a first upper switch Q1 (31) and a first lower switch Q2 (32) are included in one leg and two switches, that is, a second upper switch Q3 (33) and a second lower switch Q4 (34) are included in the other leg.

FIG. 4C is a circuit diagram including a detector for detecting the zero crossing of an input voltage in a semi-bridgeless PFC power conversion device according to an embodiment of the disclosure.

Throughout the specification, the semi-bridgeless PFC power conversion device is also referred to as a semi-bridgeless power conversion device 2000_3.

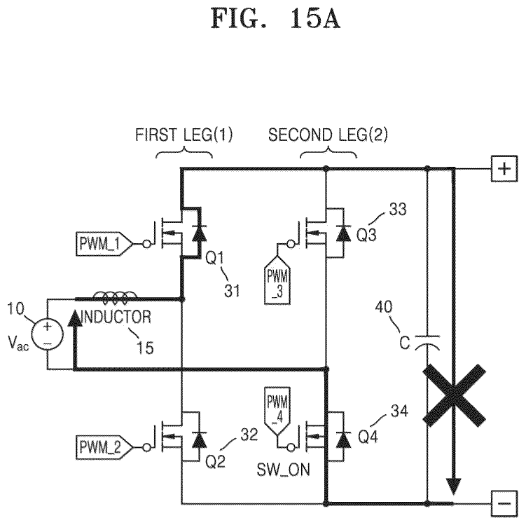

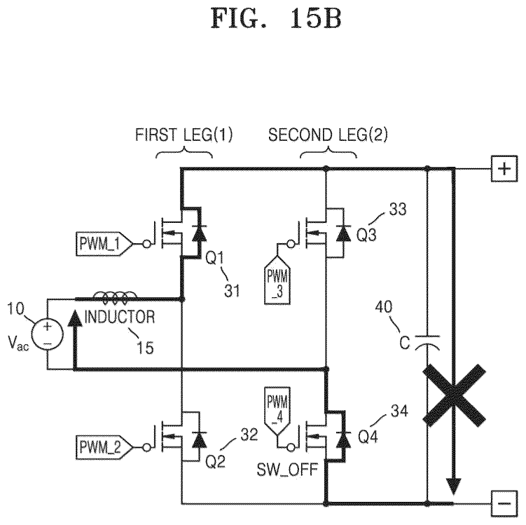

Referring to FIG. 4C, as in FIGS. 4A and 4B, an input voltage sensor 11 senses an voltage of the input voltage supplier 10, and the sensed voltage of the input voltage supplier 10 is transmitted to a phase estimator 120. The phase estimator 120 estimates the phase of the voltage of the input voltage supplier 10, and a zero crossing detector 150 detects the zero crossing of the voltage of the input voltage supplier 10 through the estimated phase. According to an embodiment of the disclosure, the zero crossing detector 150 is a block that changes a main operation switch without providing a separate non-switching period near the zero crossing of the voltage of the input voltage supplier 10. The details of the main operation switch change are described with reference to FIGS. 15A to 18B below.

Through an estimated phase, a PWM controller 170 outputs PWM switching signals PWM_5 and PWM_6 for switching Q5 (35) and Q6 (36) of the semi-bridgeless power conversion device 2000_3 and transmits the PWM switching signal to the two switches. One leg of the semi-bridgeless power conversion device 2000_3 according to FIG. 4C includes a first upper diode D3 (43) and a first lower switch Q5 (35), and the other leg includes a second upper diode D4 (44) and a second lower switch Q6 (36).

Hereinafter, when a power conversion device 2000 is referred to, unless otherwise specifically stated, the power conversion device 2000 collectively refers to the unidirectional totem pole power conversion device 2000_1, the bidirectional totem pole power conversion device 2000_2, and the semi-bridgeless power conversion device 2000_3.

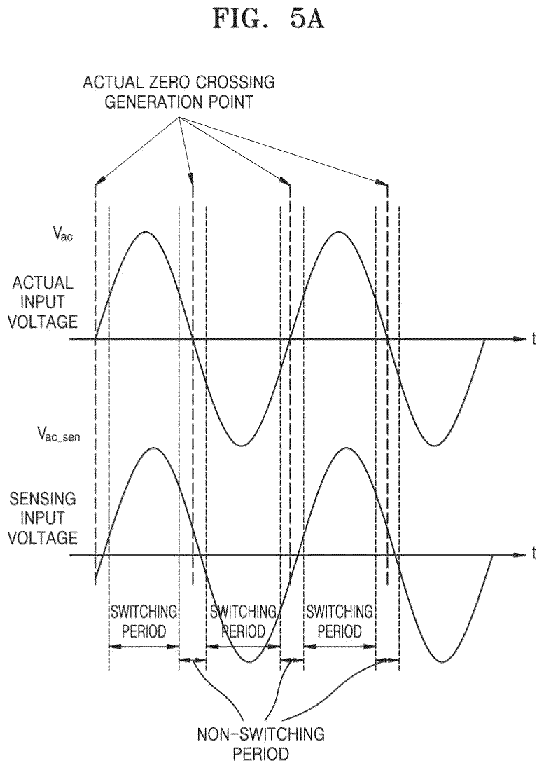

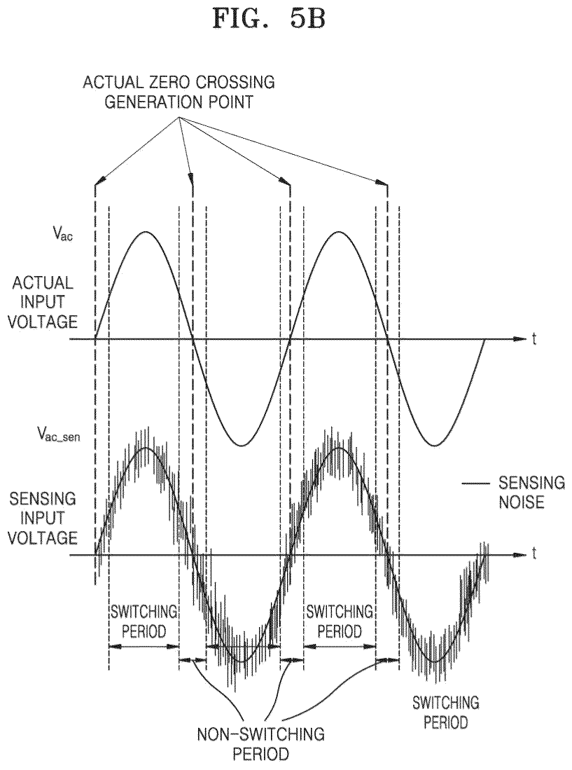

FIG. 5A is a waveform diagram comparing an actual input voltage with a sensed input voltage in a power conversion device.

When detecting the zero crossing point of an AC input voltage, polarity detection is basically performed based on a sensing signal of the voltage of the input voltage supplier 10 of the power conversion device 2000. Referring to FIG. 5A, when comparing the actual voltage of the input voltage supplier 10 with the sensed input voltage, the sensed input voltage shows a slight phase delay compared to the actual voltage of the input voltage supplier 10 due to circuit delay, noise, AD conversion delay in a microcomputer, etc. Therefore, because it is not possible to know the extent of the slight phase delay, the phase delay is predicted to some extent and a non-switching period is set during PWM switching in the power conversion device 2000 by including a margin somewhat larger than the phase delay. In addition, because it is not possible to know the extent of the slight phase delay, the actual polarity and the sensed polarity of the voltage of the input voltage supplier 10 may be different from each other near the zero crossing.

FIG. 5B is a waveform diagram comparing the actual input voltage and the sensed input voltage in the power conversion device.

Referring to FIG. 5B, the sensed input voltage includes noise when compared to FIG. 5A. The noise may include at least some of the switching noise of the power conversion device 2000 and the white noise of a sensing circuit. When compared to FIG. 5A, a sensed input voltage according to FIG. 5B frequently changes polarity due to noise near the zero crossing. In other words, even when the voltage of the input voltage supplier 10 has a positive (+) value greater than 0, the voltage of the input voltage supplier 10 may be determined to have a negative (−) value due to a noise voltage, and conversely, even when the voltage of the input voltage supplier 10 has a negative (−) value less than 0, the voltage of the input voltage supplier 10 may be determined to have a positive (+) value due to the noise voltage. That is, because an actual sensed voltage is small near the zero crossing of the voltage of the input voltage supplier 10, polarity determination may be incorrect due to noise voltage in a zero crossing period of the voltage of the input voltage supplier 10, and therefore, the power conversion device 2000 has difficulty in determining a PWM switching pattern near the zero crossing.

Ideally, a method may be considered to set a non-switching period during PWM switching near the zero crossing by numerically calculating the sensing signal delay, noise, etc. according to FIGS. 5A and 5B. However, it is nearly impossible to derive an ideal non-switching time by considering all the reasons, such as stray impedance of the circuit of the power conversion device 2000, nonlinearity of impedance of a power semiconductor element, unpredictable white noise, and filter parameter tolerance. Therefore, in existing techniques, a wide period is designated in this period to stop—turn off—the switching of all switches.

When all switches are turned off, the current becomes 0 in a certain period near the zero crossing point of the voltage of the input voltage supplier 10, which leads to difficulties in designing a filter to reduce power factor reduction, harmonic increase, and sensing circuit noise. In addition, because the length of the non-switching period has to be determined experimentally through repeated trial-and-error rather than a theoretical method, problems such as reduced development efficiency may occur.

Therefore, in the disclosure, a power conversion device, which employs a seamless zero crossing detection method that eliminates a non-switching period near the zero crossing point of the voltage of the input voltage supplier 10 and solves the problem of incorrectly determining polarity at the zero crossing point with a simple PWM signal pattern, is provided.

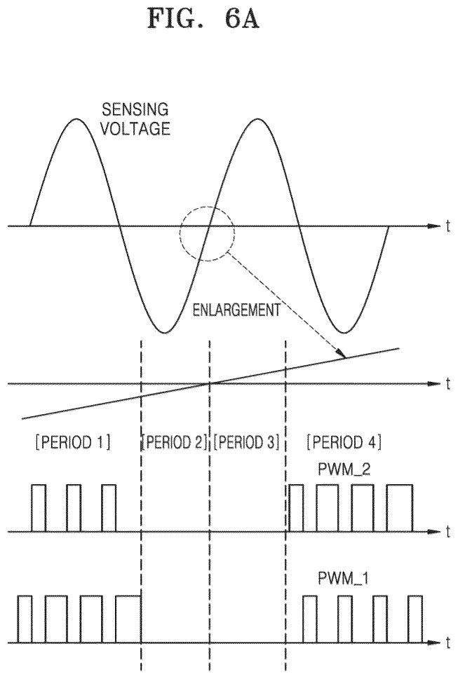

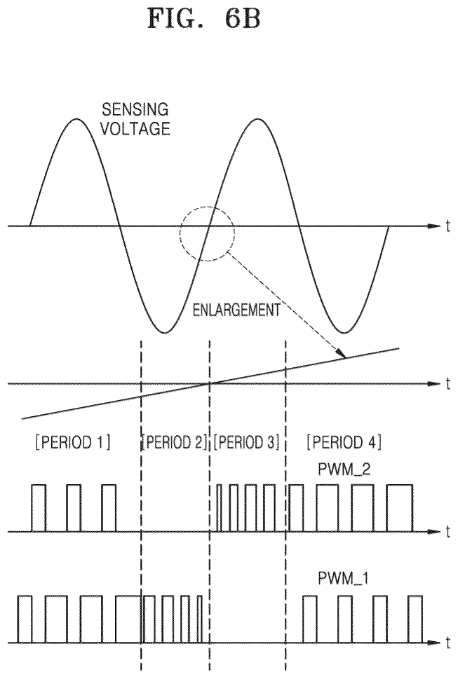

FIG. 6A is a waveform diagram in which a non-switching period is near the zero crossing of an input voltage.

Referring to FIG. 6A, a PWM switching pattern, in which all switches are turned off in a period in which the input voltage V_{ac} zero-crosses, is illustrated. However, when a period in which all switches are turned off near the zero crossing occurs, it will not only result in a decrease in the power conversion efficiency of the system, but also increase the harmonics of the system.

As shown in FIG. 6A, when the zero crossing point of a sensed input voltage is enlarged, it may be divided into Periods 1 to 4. Period 1 is a period in which the sensed input voltage moves from a negative (−) value to zero, and is a period in which PWM switching is still performed. Period 2 is a period in which the sensed input voltage moves from a negative (−) value to zero, just like Period 1. However, because the voltage of the input voltage supplier 10 is almost close to zero and an actual input voltage may have already changed from zero to a positive (+) value, and the voltage of the input voltage supplier 10 may go back and forth between positive (+) and negative (−) due to noise, Period 2 is a period in which PWM switching is not performed. Period 3 is a period in which the sensing input voltage changes from zero to a positive (+) value. However, because the voltage of the input voltage supplier 10 has a value close to zero and an actual input voltage may still have a negative (−) value, Period 3 is a period in which PWM switching is not performed, just like in Period 2. Period 4 is a period in which it is determined that the sensing input voltage has sufficiently moved away from a near-zero value and has a positive (+) value and PWM switching is resumed.

FIG. 6B is a waveform diagram showing PWM switching performed near the zero crossing of an input voltage in a power conversion device according to an embodiment of the disclosure.

When compared to FIG. 6A, as shown in FIG. 6B, the power conversion device 2000 performs PWM switching in Periods 2 and 3 according to an embodiment of the disclosure. First, in Period 2, the sensing input voltage is moving from a negative (−) value to zero and the voltage of the input voltage supplier 10 is approaching almost zero, and at this time, as shown in FIG. 6B, only one switch may perform PWM switching (PWM_1 switching by an upper switch) according to an embodiment. According to an embodiment, in Period 2, the duty ratio of the PWM switching pattern may be reduced more than that at the beginning of Period 2 because the voltage of the input voltage supplier 10 will be closest to zero at the end of Period 2. On the other hand, Period 3 is a period in which the sensing input voltage changes from zero to a positive (+) value and the voltage of the input voltage supplier 10 has a value close to zero. In Period 3, as shown in FIG. 6B, only one other switch may perform PWM switching (PWM_2 switching by a lower switch) according to an embodiment. In an embodiment, unlike in Period 2, in the early part of Period 3, the voltage of the input voltage supplier 10 will be closest to zero and thus the duty ratio of the PWM switching pattern may be made the smallest, and in the late part of Period 3, the voltage of the input voltage supplier 10 will be farthest from zero and thus the duty ratio of the PWM switching pattern may be increased more than in the early part of Period 3.

When PWM switching is performed as above in Periods 2 and 3, spike current does not occur near the zero crossing of the voltage of the input voltage supplier 10. In other words, even when the actual voltage of the input voltage supplier 10 is positive (+) and the sensing input voltage is negative (−) in Period 2, or even when the actual voltage of the input voltage supplier 10 is negative (−) and the sensing input voltage is positive (+) in Period 3, spike current does not occur. The reason for this is explained below with reference to FIGS. 7A to 18B. Hereinafter, Period 2 means a period in which the sensed input voltage approaches zero from a predetermined first point, a negative (−) value, as shown in Period 2 of FIG. 6B, and corresponds to Period 2 of FIG. 6B. In addition, Period 3 means a period in which the sensed input voltage increases from zero to a second predetermined point, a positive (+) value, as shown in Period 3 of FIG. 6B, and corresponds to Period 3 of FIG. 6B.

FIGS. 7A and 7B are circuit diagrams each showing an operating switch and a current flow diagram under an abnormal condition in Period 2 in a unidirectional totem pole power conversion device according to an embodiment of the disclosure.

The unidirectional totem pole power conversion device 2000_1 according to an embodiment of the disclosure may include a first leg 1 composed of a first upper switch Q1 (31) and a first lower switch Q2 (32), and a diode leg 5 composed of an upper diode D1 (41) and a lower diode D2 (42). A control unit (not shown) of the unidirectional totem pole power conversion device 2000_1 includes at least one processor (not shown) that controls the switching of two switches Q1 (31) and Q2 (32) included in the first leg 1.

First, FIG. 7A and FIG. 7B are current flow diagrams for Period 2 in which only the first upper switch Q1 (31) operates in an abnormal condition in which the actual voltage of the input voltage supplier 10 is positive (+) and the sensing input voltage is negative (−) in the unidirectional totem pole bridgeless PFC power conversion device 2000_1.

The circuit diagram of FIG. 7A is a circuit diagram showing a case in which only the upper switch Q1 (31) of the first leg 1 operates in an abnormal condition in which, in Period 2, the sensing input voltage is negative (−) and the actual voltage of the input voltage supplier 10 is positive (+). When the lower switch Q2 (32) of the unidirectional totem pole power conversion device 2000_1 is turned off and only the upper switch Q1 (31) is turned on, the unidirectional totem pole power conversion device 2000_1 operates like a diode rectifier, and due to the reverse bias of the diode, a charging period of the inductor 15 does not occur and power flow is not formed, and thus, actual current flowing in the circuit at this time is 0. In other words, because the voltage of the DC link capacitor 40 is higher than the maximum value of the voltage of the input voltage supplier 10 in a normal state, the diode is turned off. Similarly, when Q1 (31) is turned off in FIG. 7B, the charging period of the inductor 15 does not occur and power flow is not formed, and thus, the actual current flowing in the circuit at this time is 0.

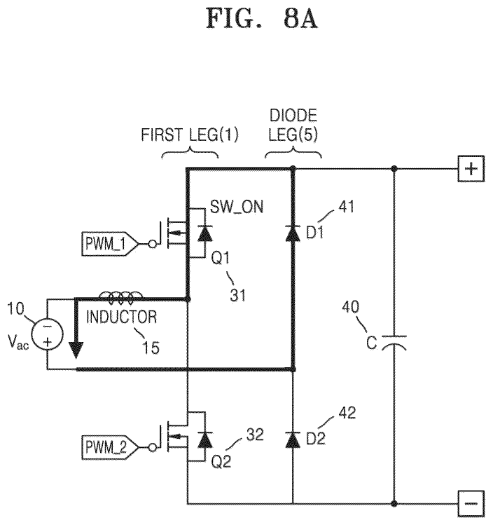

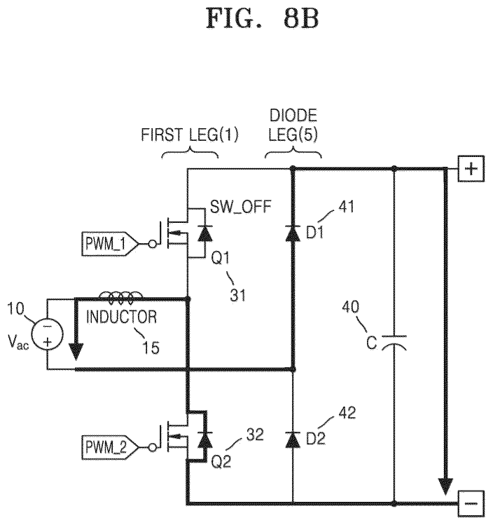

FIGS. 8A and 8B are circuit diagrams each showing an operating switch and a current flow diagram under a normal condition in Period 2 in a unidirectional totem pole power conversion device according to an embodiment of the disclosure.

With reference to FIGS. 8A and 8B, the condition of a normal period in which, in Period 2, both the sensed input voltage and the actual voltage of the input voltage supplier 10 are negative (−) is described below. In existing techniques, even when a period, in which both the sensed input voltage and the actual voltage of the input voltage supplier 10 are negative, occurs in Period 2, because all switches are turned off, current does not flow through the diode due to a voltage across the DC link capacitor 40, and thus, the current flowing in the system becomes 0.

On the other hand, as shown in FIG. 8A, when only the first upper switch Q1 (31) is switched on in the first leg 1 including Q1 (31) and Q2 (32), a period, in which a current flows through Q1 (31) and the inductor 15 via D1 (41) and the inductor 15 is charged, occurs.

In FIG. 8B, when the first upper switch Q1 (31) is switched off, voltage boosting occurs as a path, in which a current flows through D1 (41), the DC link capacitor 40, the anti-parallel diode of Q2 (32), and the inductor 15, is formed. In this case, a period in which a power flow is normally formed and the current becomes 0 may be minimized. Therefore, unlike the case where all switches are turned off when a period in which both the sensed input voltage and the actual voltage of the input voltage supplier 10 are negative occurs in Period 2, according to the switching method in Period 2 of the disclosure, a voltage boosting mode is formed so that a current flows in the system, and thus, harmonics of the system may be reduced and current spikes may be prevented.

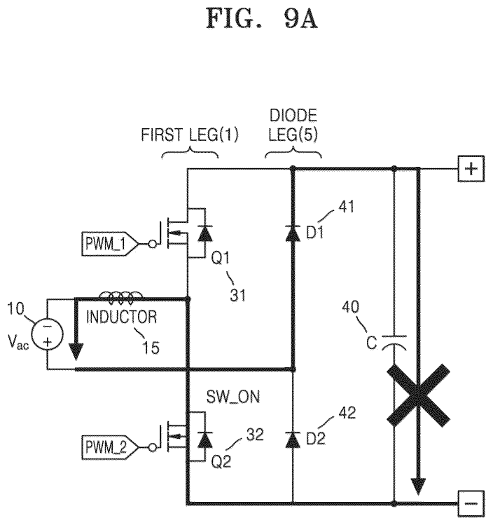

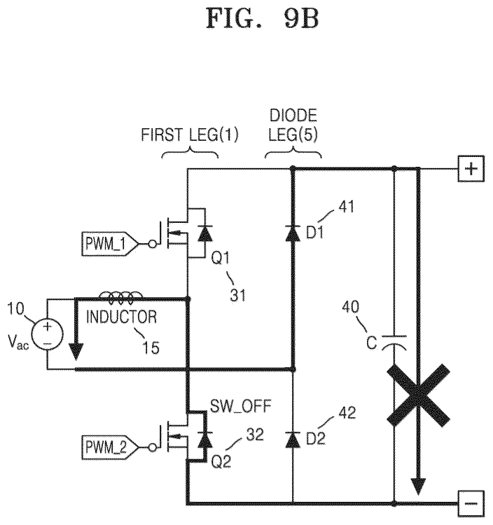

FIGS. 9A and 9B are circuit diagrams each showing an operating switch and a current flow diagram under an abnormal condition in Period 3 in a unidirectional totem pole power conversion device according to an embodiment of the disclosure.

FIGS. 9A and 9B are circuit diagrams showing that only the first lower switch Q2 (32) in the first leg 1 is turned on and off in an abnormal condition in which, in Period 3, the sensing input voltage is positive (+) and the actual voltage of the input voltage supplier 10 is negative (−).

FIG. 9A shows a case where only the first lower switch Q2 (32) in the first leg 1 is turned on in the abnormal condition, and FIG. 9B shows a case where only the first lower switch Q2 (32) in the first leg 1 is turned off in the abnormal condition. In this case, a current forms a path that may pass through D1 (41), the DC link capacitor 40, and Q2 (32) that is turned on or the anti-parallel diode of Q2 (32), and in this case, because the voltage of the DC link capacitor 40 is higher than the maximum value of the voltage of the input voltage supplier 10, the diode is turned off and no power flow is formed. Therefore, no current actually flows and no charging period of the inductor 15 occurs.

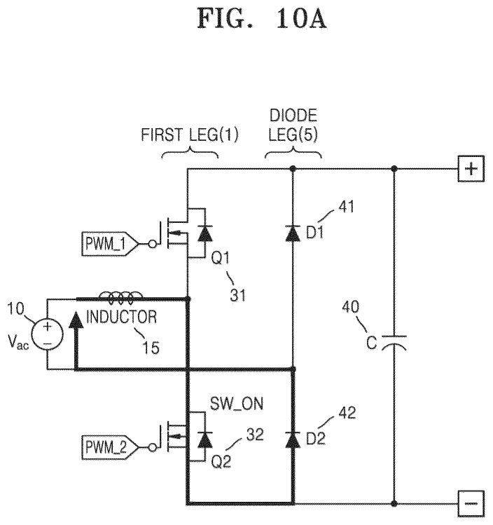

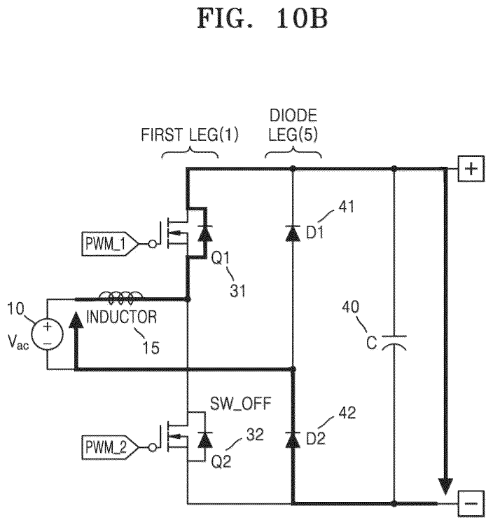

FIGS. 10A and 10B are circuit diagrams each showing an operating switch and a current flow diagram under a normal condition in Period 3 in a unidirectional totem pole power conversion device according to an embodiment of the disclosure.

FIGS. 10A and 10B are circuit diagrams showing that only the first lower switch Q2 (32) in the first leg 1 is turned on and off in a normal condition in which, in Period 3, the sensing input voltage is positive (+) and the actual voltage of the input voltage supplier 10 is also positive (+).

FIG. 10A shows a current path when the first lower switch Q2 (32) of the first leg 1 is turned on, and FIG. 10B shows a current path when the first lower switch Q2 (32) of the first leg 1 is turned off.

Referring to FIG. 10A, under a normal condition, a current path through the inductor 15—Q2 (32)—D2 (42) occurs, and in this case, power is charged in the inductor 15. In FIG. 10B, where Q2 (32) is turned off, a current path through the anti-parallel diode of Q1 (31)—the DC link capacitor 40—D2 (42) is formed and the unidirectional totem pole power conversion device 2000_1 operates in a boosting mode. Therefore, according to FIGS. 10A and 10B, because the actual current flows in Period 3, it is possible to prevent a period, in which the current becomes 0, from occurring as in the existing technique.

As described above with reference to FIGS. 7A to 10B, at least one processor detects a predetermined period point in time when the sensed voltage of the input voltage supplier 10 approaches zero from negative in the unidirectional totem pole power conversion device 2000_1 and controls only the first upper switch Q1 (31) of the first leg 1 to be switched from a predetermined period (Period 2) point in time according to the detection. At least one processor in the unidirectional totem pole power conversion device 2000_1 detects a point in time when the sensed voltage of the input voltage supplier 10 rises from zero to positive, and controls only the first lower switch Q2 (32) of the first leg 1 to be switched from a point in time when the sensed voltage of the input voltage supplier 10 becomes zero to the predetermined period (Period 3) point in time according to the detection.

FIGS. 11A and 11B are circuit diagrams each showing an operating switch and a current flow diagram under an abnormal condition in Period 2 in a bidirectional totem pole power conversion device according to an embodiment of the disclosure.

The bidirectional totem pole power conversion device 2000_2 according to an embodiment of the disclosure may include a first leg 1 composed of a first upper switch Q1 (31) and a first lower switch Q2 (32), and a second leg 2 composed of a second upper switch Q3 (33) and a second lower switch Q4 (34). A control unit (not shown) of the bidirectional totem pole conversion device 2000_2 may include at least one processor that controls the switching of two switches Q1 (31) and Q2 (32) included in the first leg 1 and two switches Q3 (33) and Q4 (34) included in the second leg 2. As described with reference to FIGS. 11A to 18B, the at least one processor may detect a predetermined period point in time when the voltage of the input voltage supplier 10 approaches zero from negative in the bidirectional totem pole power conversion device 2000_2, detect a predetermined period (Period 2) according to the detection and a predetermined period point in time when the voltage of the input voltage supplier 10 rises from zero to positive, and minimize a period in which the current becomes 0 by switching only an upper switch or a lower switch of any one leg during a predetermined period (Period 3) according to the detection.

First, FIGS. 11A and 11B show an operation of the bidirectional totem pole power conversion device 2000_2 in an abnormal condition in which, in Period 2, the actual voltage of the input voltage supplier 10 is positive (+) and the sensed input voltage is negative (−). FIGS. 11A and 11B are current flow diagrams when only the first upper switch Q1 (31) operates in an abnormal condition in Period 2 in the bidirectional totem pole power conversion device 2000_2.

The circuit diagram of FIG. 11A is a circuit diagram showing a case in which only the first upper switch Q1 (31) of the first leg 1 is turned on in an abnormal condition in which, in Period 2, the sensing input voltage is negative (−) and the actual voltage of the input voltage supplier 10 is positive (+). According to FIG. 11A, a current flow forms a path through the inductor 15—Q1 (31)—the DC link capacitor 40—the anti-parallel diode of Q4 (34). FIG. 11B shows a case where the first upper switch Q1 (31) of the first leg 1 is turned off in an abnormal condition in which, in Period 2, the sensing input voltage is negative (−) and the actual input voltage (10) is positive (+). According to FIG. 11B, a current flows through a path through the inductor 15—the anti-parallel diode of Q1 (31)—the DC link capacitor 40—the anti-parallel diode of Q4 (34). According to FIGS. 11A and 11B, the bidirectional totem pole power conversion device 2000_2 operates like a diode rectifier, and due to the reverse bias of the diode, a charging period of the inductor 15 does not occur and power flow is not formed, and thus, actual current flowing in the circuit is 0. In other words, because the voltage of the DC link capacitor 40 is higher than the maximum value of the voltage of the input voltage supplier 10 in an abnormal state, the diode is turned off.

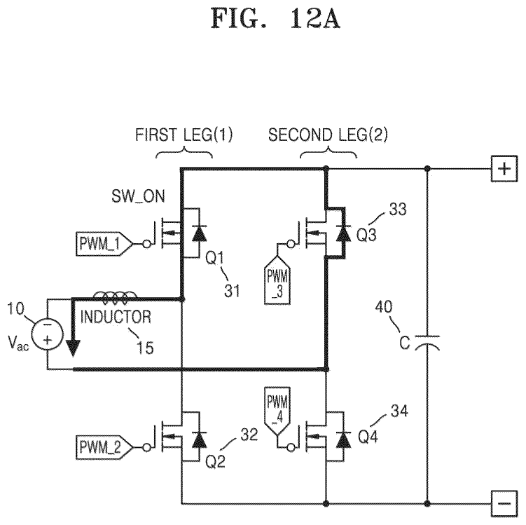

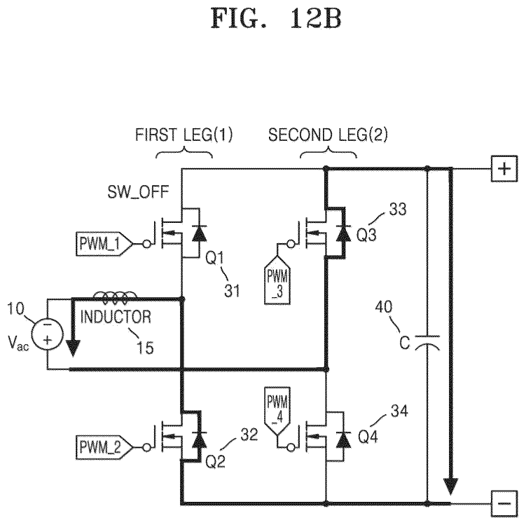

FIGS. 12A and 12B are circuit diagrams each showing an operating switch and a current flow diagram under a normal condition in Period 2 in a bidirectional totem pole power conversion device according to an embodiment of the disclosure.

With reference to FIGS. 12A and 12B, a normal condition in which, in Period 2, both the sensed input voltage and the actual voltage of the input voltage supplier 10 are negative (−) is described below. In existing techniques, even when a period, in which both the sensed input voltage and the actual voltage of the input voltage supplier 10 are negative, occurs in Period 2, because all switches are turned off, current does not flow through the diode due to a voltage across the DC link capacitor 40, and thus, the current flowing in the system becomes 0.

On the other hand, as shown in FIG. 12A, when only the first upper switch Q1 (31) is switched on in the first leg 1 including Q1 (31) and Q2 (32), a period, in which the inductor 15 is charged as a current flows through the anti-parallel diode of Q3 (33)—Q1 (31)—the inductor 15, occurs.

In FIG. 12B, when the upper switch Q1 (31) is switched off, a current forms a path through the anti-parallel diode of Q3 (33)—the DC link capacitor 40—the anti-parallel diode of Q2 (32)—the inductor 15, thereby causing voltage boosting, and a power flow is normally formed, and thus, a period in which the current becomes 0 may be minimized. Therefore, unlike the case where all switches are turned off even when a period in which both the sensed input voltage and the actual voltage of the input voltage supplier 10 are negative occurs in Period 2, a boosting mode in which switching occurs is formed in the bidirectional totem pole power conversion device 2000_2, as shown in FIGS. 12A and 12B, so that current does not become 0 and the current flows in the system, and thus, harmonics may be reduced and current spikes may be prevented.

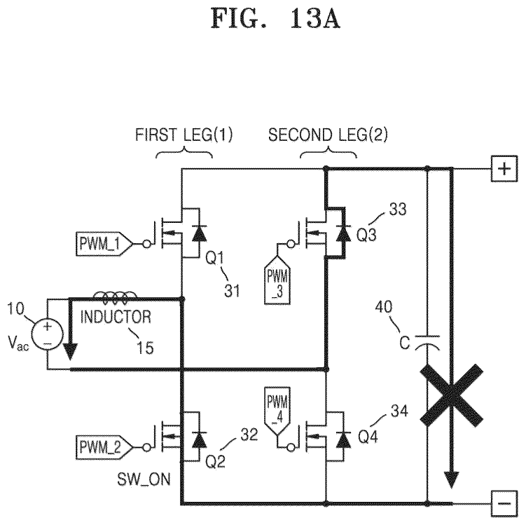

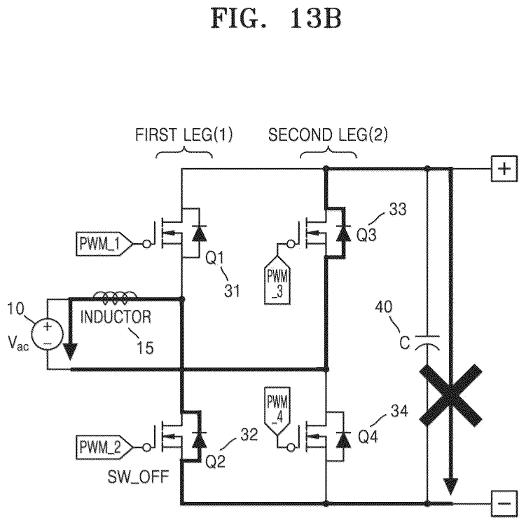

FIGS. 13A and 13B are circuit diagrams each showing an operating switch and a current flow diagram under an abnormal condition in Period 3 in a bidirectional totem pole power conversion device according to an embodiment of the disclosure.

FIGS. 13A and 13B are circuit diagrams showing that only the first lower switch Q2 (32) in the first leg 1 is turned on and off in an abnormal condition in which, in Period 3, the sensing input voltage is positive (+) and the actual voltage of the input voltage supplier 10 is negative (−).

FIG. 13A shows a case where only the first lower switch Q2 (32) in the first leg 1 is turned on in the abnormal condition, and FIG. 13B shows a case where only the first lower switch Q2 (32) in the first leg 1 is turned off in the abnormal condition. In FIG. 13A, a current forms a path that may pass through the anti-parallel diode of Q3 (33)—the DC link capacitor 40—Q2 (32)—the inductor 15, and in FIG. 13B, when the switch Q1 (31) is turned off, a current forms a path that may pass through the anti-parallel diode of Q3 (33)—the DC link capacitor 40—the anti-parallel diode of Q2 (32)—the inductor 15. In this case, because the voltage of the DC link capacitor 40 is higher than the maximum value of the voltage of the input voltage supplier 10, the diode is turned off and no power flow is formed, and thus, current does not actually flow and the charging period of the inductor 15 does not occur.

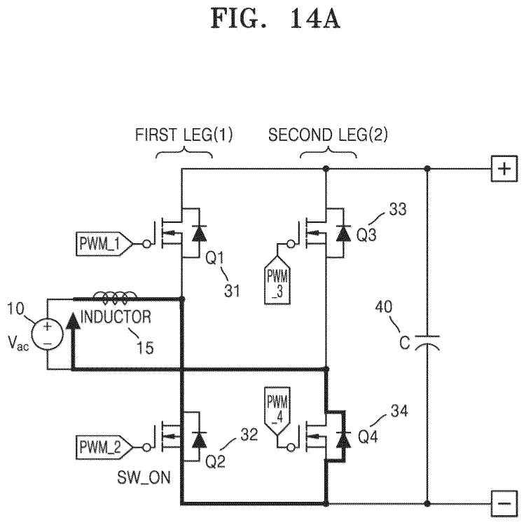

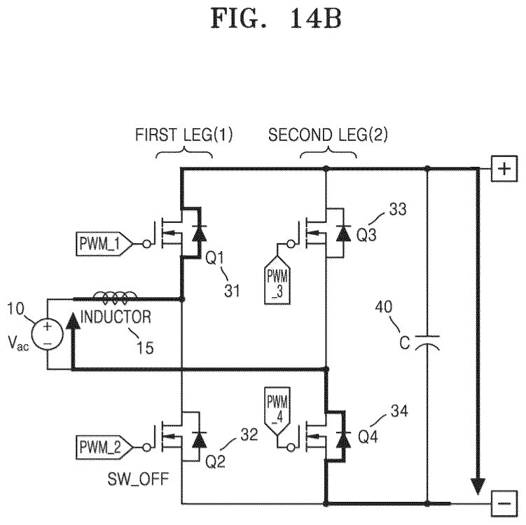

FIGS. 14A and 14B are circuit diagrams each showing an operating switch and a current flow diagram under a normal condition in Period 3 in a bidirectional totem pole power conversion device according to an embodiment of the disclosure.

FIGS. 14A and 14B are circuit diagrams showing that only the first lower switch Q2 (32) in the first leg 1 is turned on and off in a normal condition in which, in Period 3, the sensing input voltage is positive (+) and the actual voltage of the input voltage supplier 10 is also positive (+).

FIG. 14A shows a current path when the first lower switch Q2 (32) of the first leg 1 is turned on, and FIG. 14B shows a current path when the first lower switch Q2 (32) of the first leg 1 is turned off.

Referring to FIG. 14A, under a normal condition, a current path through the inductor 15—Q2 (32)—the anti-parallel diode of Q4 (34) occurs, and in this case, power is charged in the inductor 15. In FIG. 14B, where Q2 (32) is turned off, a current path through the inductor 15—the anti-parallel diode of Q1 (31)—the DC link capacitor 40—the anti-parallel diode of Q4 (34) is formed, and thus, the bidirectional totem pole power conversion device 2000_2 operates in a voltage boosting mode. Therefore, according to FIGS. 14A and 14B, a period in which current becomes 0 in Period 3 may be minimized.

FIGS. 11A to 14B illustrate a circuit diagram in which the bidirectional totem pole power conversion device 2000_2 switches only one of the first upper switch Q1 (31) or the first lower switch Q2 (32) of the first leg 1 in Periods 2 and 3 where the zero crossing of FIG. 6B occurs. Because the bidirectional totem pole power conversion device 2000_2 usually uses a high-speed switch for switching in the first leg 1 and a low-speed switch for rectification in the second leg 2, it is necessary to switch the switch of the first leg 1 as shown in FIGS. 11A to 14B. However, when the bidirectional totem pole power conversion device 2000_2 uses a low-speed switch for rectification in the first leg 1 and a high-speed switch for switching in the second leg 2 for design reasons, it is necessary to perform the switching at zero crossing according to an embodiment of the disclosure through the switch of the second leg 2.

FIGS. 15A and 15B are circuit diagrams each showing an operating switch and a current flow diagram under an abnormal condition in Period 2 in a bidirectional totem pole power conversion device according to an embodiment of the disclosure.

First, FIGS. 15A and 15B show an operation of the bidirectional totem pole power conversion device 2000_2 in an abnormal condition in which, in Period 2, the actual voltage of the input voltage supplier 10 is positive (+) and the sensed input voltage is negative (−). FIGS. 15A and 15B are current flow diagrams for the case where only the second lower switch Q4 (34) of the second leg 2 operates in an abnormal condition in Period 2 in the bidirectional totem pole power conversion device 2000_2.

The circuit diagram of FIG. 15A is a circuit diagram showing a case in which only the second lower switch Q4 (34) of the second leg 2 is turned on in an abnormal condition in which, in Period 2, the sensing input voltage is negative (−) and the actual voltage of the input voltage supplier 10 is positive (+). According to FIGS. 15A, a current flow forms a path through the inductor 15—the anti-parallel diode of Q1 (31)—the DC link capacitor 40—Q4 (34). FIG. 11B shows a case where the second lower switch Q4 (34) of the second leg 2 is turned off in an abnormal condition in which, in Period 2, the sensing input voltage is negative (−) and the actual input voltage (10) is positive (+). According to FIG. 15B, a current flow forms a path through the inductor 15—the anti-parallel diode of Q1 (31)—the DC link capacitor 40—the anti-parallel diode of Q4 (34). According to FIGS. 15A and 15B, the bidirectional totem pole power conversion device 2000_2 operates like a diode rectifier, and due to the reverse bias of the diode, a charging period of the inductor 15 does not occur and power flow is not formed, and thus, actual current flowing in the circuit is 0. In other words, because the voltage of the DC link capacitor 40 is higher than the maximum value of the voltage of the input voltage supplier 10 in an abnormal state, the diode is turned off.

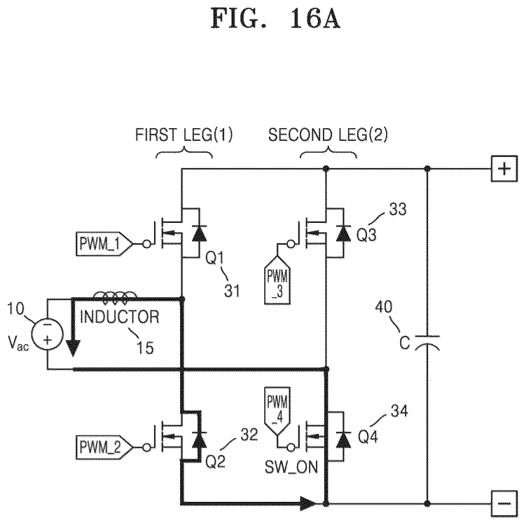

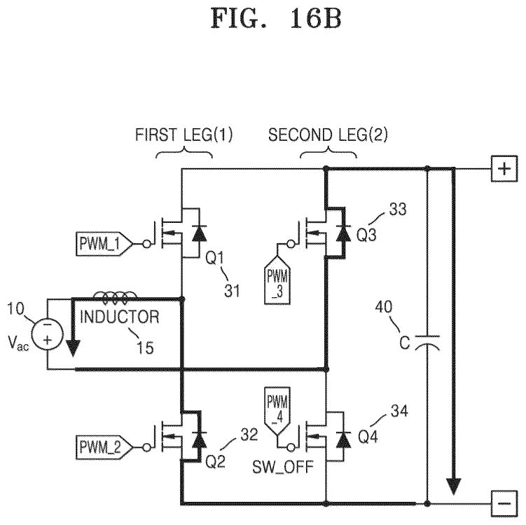

FIGS. 16A and 16B are circuit diagrams each showing an operating switch and a current flow diagram under a normal condition in Period 2 in a bidirectional totem pole power conversion device according to an embodiment of the disclosure.

With reference to FIGS. 16A and 16B, a normal condition in which, in Period 2, both the sensed input voltage and the actual voltage of the input voltage supplier 10 are negative (−) is described below. In existing techniques, even when a period, in which both the sensed input voltage and the actual voltage of the input voltage supplier 10 are negative, occurs in Period 2, because all switches are turned off, the current flowing in the system becomes 0.

On the other hand, as shown in FIG. 16A, when only the second lower switch Q4 (34) in the second leg 2 is switched on, a period, in which a current flows through Q4 (34)—the anti-parallel diode of Q3 (33)—inductor 15 and the inductor 15 is charged, occurs.

In FIG. 16B, when the second lower switch Q4 (34) in the second leg 2 is switched off, a current forms a path through the anti-parallel diode of Q3 (33)—the DC link capacitor 40—the anti-parallel diode of Q2 (32)—the inductor 15, thereby causing voltage boosting, and a power flow is normally formed, and thus, a period in which the current becomes 0 may be minimized. Therefore, unlike the case where all switches are turned off even when a period in which both the sensed input voltage and the actual voltage of the input voltage supplier 10 are negative occurs in Period 2, a voltage boosting mode is formed in the bidirectional totem pole power conversion device 2000_2, as shown in FIGS. 16A and 16B, so that current does not become 0 and the current flows in the system, and thus, harmonics may be reduced and current spikes may be prevented.

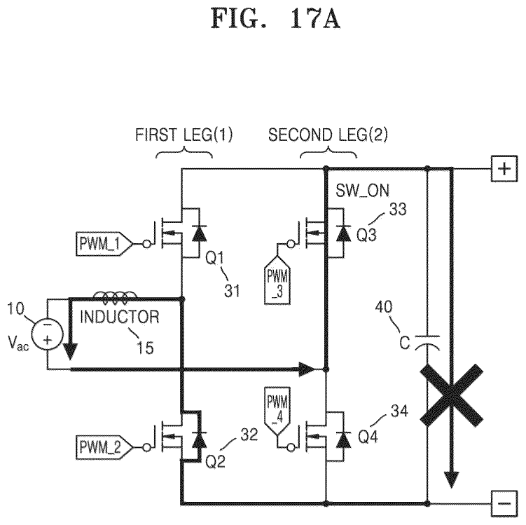

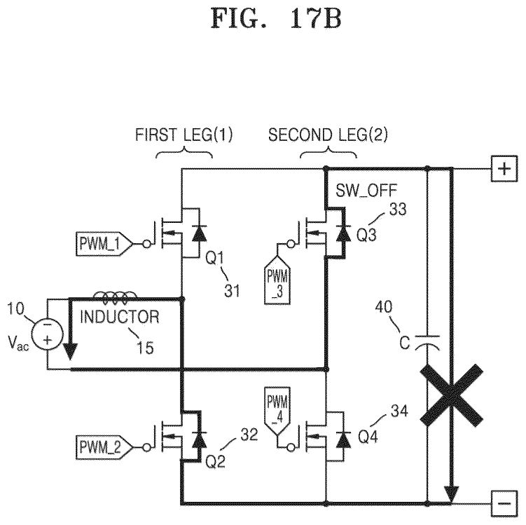

FIGS. 17A and 17B are circuit diagrams each showing an operating switches and a current flow diagram under an abnormal condition in Period 3 in a bidirectional totem pole power conversion device according to an embodiment of the disclosure.

FIGS. 17A and 17B are circuit diagrams showing that only the second upper switch Q3 (33) in the second leg 2 is turned on and off in an abnormal condition in which, in Period 3, the sensing input voltage is positive (+) and the actual voltage of the input voltage supplier 10 is negative (−).

FIG. 17A shows a case where only the second upper switch Q3 (33) in the second leg 2 is turned on in the abnormal condition, and FIG. 17B shows a case where only the second upper switch Q3 (33) in the second leg 2 is turned off in the abnormal condition. In FIG. 17A, a current forms a path that may pass through Q3 (33)—the DC link capacitor 40—the anti-parallel diode of Q2 (32)—the inductor 15. In FIG. 17B, when Q3 (33) is turned off, a current forms a path that may pass through the anti-parallel diode of Q3 (33)—the DC link capacitor 40—the anti-parallel diode of Q2 (32)—the inductor 15. In this case, because the voltage of the DC link capacitor 40 is higher than the maximum value of the voltage of the input voltage supplier 10, the diode is turned off and no power flow is formed, and thus, current does not actually flow and the charging period of the inductor 15 does not occur.

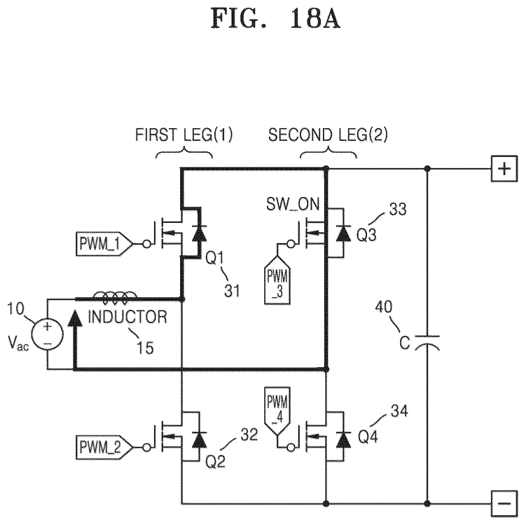

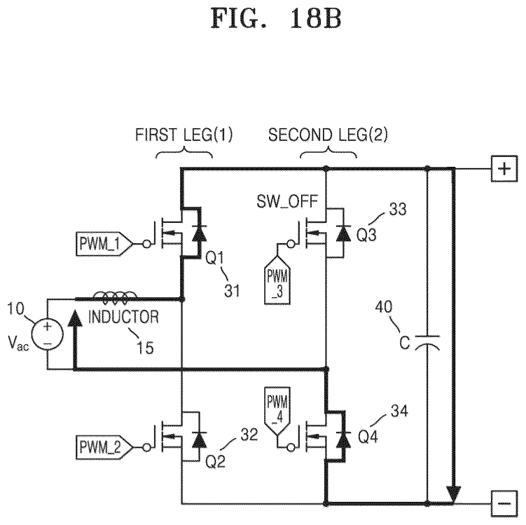

FIGS. 18A and 18B are circuit diagrams each showing an operating switch and a current flow diagram under a normal condition in Period 3 in a bidirectional totem pole power conversion device according to an embodiment of the disclosure.

FIGS. 18A and 18B are circuit diagrams showing that only the second upper switch Q3 (33) in the second leg 2 is turned on and off in a normal condition in which, in Period 3, the sensing input voltage is positive (+) and the actual voltage of the input voltage supplier 10 is also positive (+).

FIG. 18A shows a current path when the second upper switch Q3 (33) of the second leg 2 is turned on, and FIG. 18B shows a current path when the second upper switch Q3 (33) of the second leg 2 is turned off.

Referring to FIG. 18A, under a normal condition, a current path through the inductor 15—the anti-parallel diode of Q1 (31)—Q3 (33) occurs, and in this case, power is charged in the inductor 15. In FIG. 18B, where Q3 (33) is turned off, a current path through the inductor 15—the anti-parallel diode of Q1 (31)—the DC link capacitor (40)—the anti-parallel diode of Q4 (34) is formed, and thus, the bidirectional totem pole power conversion device 2000_2 operates in a voltage boosting mode. Therefore, according to FIGS. 18A and 18B, a current path is formed in Period 3 and thus a period in which current becomes 0 may be minimized.

The bidirectional totem pole power conversion device 2000_2 according to an embodiment of the disclosure may include a first leg 1 composed of a first upper switch Q1 (31) and a first lower switch Q2 (32), and a second leg 2 composed of a second upper switch Q3 (33) and a second lower switch Q4 (34). A control unit (not shown) of the bidirectional totem pole conversion device 2000_2 may include at least one processor that controls the switching of two switches Q1 (31) and Q2 (32) included in the first leg 1 and two switches Q3 (33) and Q4 (34) included in the second leg 2. As described with reference to FIGS. 11A to 18B, the at least one processor may detect a predetermined period point in time when the voltage of the input voltage supplier 10 approaches zero from negative in the bidirectional totem pole power conversion device 2000_2, detect a predetermined period (Period 2) according to the detection and a predetermined period point in time when the voltage of the input voltage supplier 10 rises from zero to positive, and minimize a period in which the current becomes 0 by switching only an upper switch or a lower switch of any one leg during a predetermined period (Period 3) according to the detection.

According to an embodiment, the bidirectional totem pole power conversion device 2000_2 of FIGS. 11a to 14b switches the first upper switch Q1 (31) and the first lower switch Q2 (32) of the first leg 1, and in this case, the first upper switch Q1 (31) and the first lower switch Q2 (32) of the first leg 1 may use switches capable of high-speed switching that are relatively faster than the second upper switch Q3 (33) and the second lower switch Q4 (34) of the second leg 2. In FIGS. 15A to 18B, the bidirectional totem pole power conversion device 2000_2 switches the second upper switch Q3 (33) and the second lower switch Q4 (34) of the second leg 2, and in this case, the second upper switch Q3 (33) and the second lower switch Q4 (34) of the second leg 2 may use switches capable of high-speed switching that are relatively faster than the first upper switch Q1 (31) and the first lower switch Q2 (32) of the first leg 1.

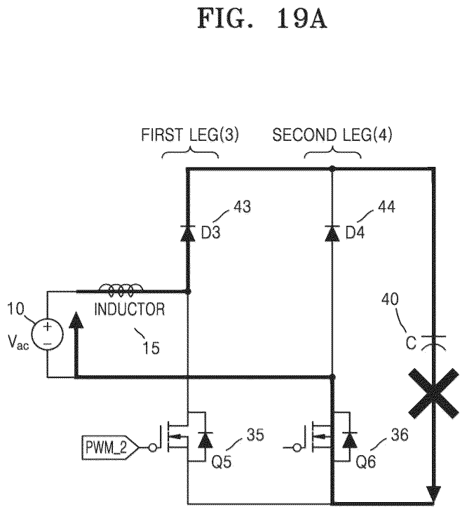

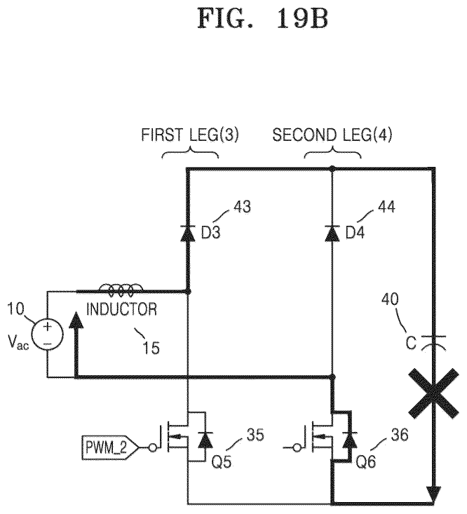

FIGS. 19A and 19B are circuit diagrams each showing an operating switch and a current flow diagram under an abnormal condition in Period 2 in a semi-bridgeless power conversion device according to an embodiment of the disclosure.

The semi-bridgeless power conversion device 2000_3 according to an embodiment of the disclosure may include a first leg 3 composed of a first upper diode D3 (43) and a first lower switch Q5 (35), and a second leg 4 composed of a second upper diode D4 (44) and a second lower switch Q6 (36). A control unit (not shown) of the semi-bridgeless power conversion device 2000_3 includes at least one processor that controls switching of the two switches Q5 (35) and Q6 (36)).

First, FIGS. 19A and 19B show an operation of the semi-bridgeless power conversion device 2000_3 in an abnormal condition in which, in Period 2, the actual voltage of the input voltage supplier 10 is positive (+) and the sensed input voltage is negative (−). FIGS. 19A and 19B are current flow diagrams when only the second lower switch Q6 (36) of the second leg 4 operates in an abnormal condition in Period 2 in the semi-bridgeless power conversion device 2000_3.

The circuit diagram of FIG. 19A is a circuit diagram showing a case in which only the second lower switch Q6 (36) of the second leg 4 is turned on in an abnormal condition in which, in Period 2, the sensing input voltage is negative (−) and the actual voltage of the input voltage supplier 10 is positive (+). According to FIG. 19A, a current flow forms a path through D3 (43)—the DC link capacitor 40—Q6 (36). FIG. 19B shows a case where the second lower switch Q6 (36) of the second leg 4 is turned off in an abnormal condition in which, in Period 2, the sensing input voltage is negative (−) and the actual voltage of the input voltage supplier 10 is positive (+) According to FIG. 15B, a current flow forms a path through D3 (43)—the DC link capacitor 40—the anti-parallel diode of Q6 (36). According to FIGS. 19A and 19B, the semi-bridgeless power conversion device 2000_3 operates like a diode rectifier, and due to the reverse bias of the diode, a charging period of the inductor 15 does not occur and power flow is not formed, and thus, actual current flowing in the circuit is 0. In other words, because the voltage of the DC link capacitor 40 is higher than the maximum value of the voltage of the input voltage supplier 10 in an abnormal state, the diode is turned off.

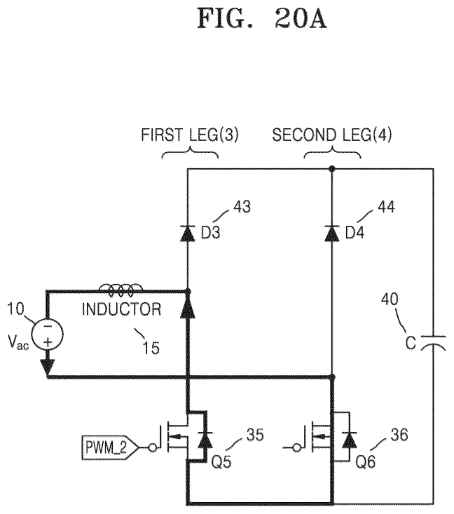

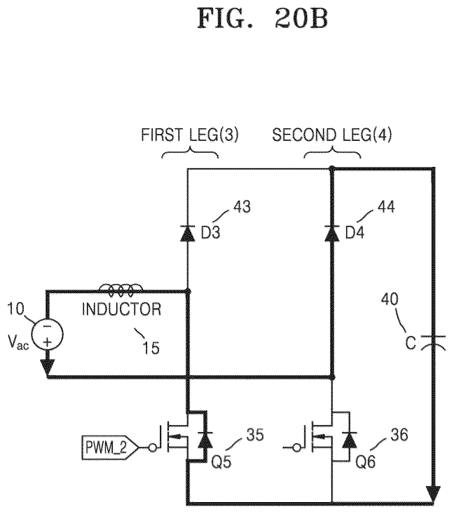

FIGS. 20A and 20B are circuit diagrams each showing an operating switch and a current flow diagram under a normal condition in Period 2 in a semi-bridgeless power conversion device according to an embodiment of the disclosure.

With reference to FIGS. 20A and 20B, a normal condition in which, in Period 2, both the sensed input voltage and the actual voltage of the input voltage supplier 10 are negative (−) is described below. In existing techniques, even when a period, in which both the sensed input voltage and the actual voltage of the input voltage supplier 10 are negative, occurs in Period 2, because all switches are turned off, the current flowing in the system becomes 0.

On the other hand, as shown in FIG. 20A, when only the second lower switch Q6 (36) in the second leg 4 is switched on, a period, in which a current flows through Q6 (36)—the anti-parallel diode of Q5 (35)—the inductor 15 and the inductor 15 is charged, occurs.

FIG. 20B is a diagram showing the switching off of the second lower switch Q6 (36) in the second leg 4. When the switch Q6 (36) is turned off, a current flow forms a path through D4 (44)—the DC link capacitor 40—the anti-parallel diode of Q5 (35)—the inductor 15, and voltage boosting occurs. Therefore, a period in which a power flow is normally formed and the current becomes 0 may be minimized. Unlike the case where all switches are turned off even when a period in which both the sensed input voltage and the actual voltage of the input voltage supplier 10 are negative occurs in Period 2, a boosting mode is formed in the semi-bridgeless power conversion device 2000_3, as shown in FIGS. 20A and 20B, so that current does not become 0 and the current flows in the system, and thus, harmonics may be reduced and current spikes may be prevented.

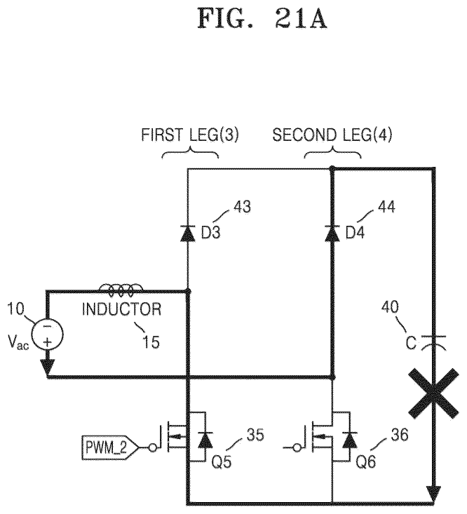

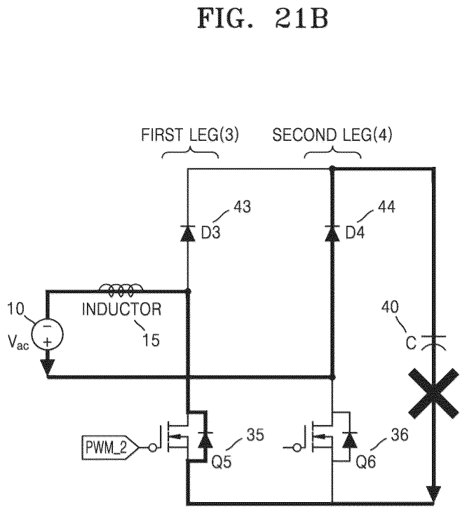

FIGS. 21A and 21B are circuit diagrams each showing an operating switch and a current flow diagram under an abnormal condition in Period 3 in a semi-bridgeless power conversion device according to an embodiment of the disclosure.

FIGS. 21A and 21B are circuit diagrams showing that only the first lower switch Q5 (35) in the first leg 3 is turned on and off in an abnormal condition in which, in Period 3, the sensing input voltage is positive (+) and the actual input voltage (10) is negative (−).

FIG. 21A shows a case where only the first lower switch Q5 (35) in the first leg 1 is turned on in the abnormal condition, and FIG. 21B shows a case where only the first lower switch Q5 (35) in the first leg 3 is turned off in the abnormal condition. In FIG. 21A, a current forms a path that may pass through D4 (44)—the DC link capacitor 40—the anti-parallel diode of Q5 (35). As in FIG. 21B, when Q5 (35) is turned off, a current forms a path that may pass through D4 (44)—the DC link capacitor (40)—the anti-parallel diode of Q5 (35). In this case, because the voltage of the DC link capacitor 40 is higher than the maximum value of the voltage of the input voltage supplier 10, the diode is turned off and no power flow is formed, and thus, current does not actually flow and the charging period of the inductor 15 does not occur.

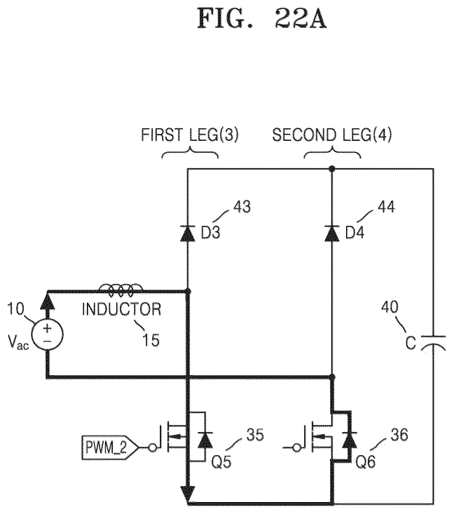

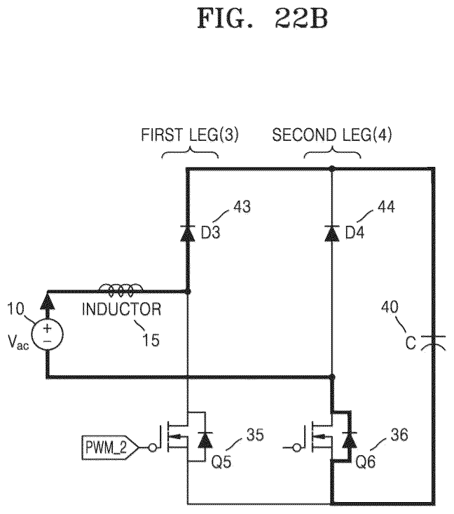

FIGS. 22A and 22B are circuit diagrams each showing an operating switch and a current flow diagram under a normal condition in Period 3 in a semi-bridgeless power conversion device according to an embodiment of the disclosure.

FIGS. 22A and 22B are circuit diagrams showing that only the first lower switch Q5 (35) in the first leg 3 is turned on and off in a normal condition in which, in Period 3, the sensing input voltage is positive (+) and the actual input voltage (10) is also positive (+).

FIG. 22A shows a current path when the first lower switch Q5 (35) of the first leg 3 is turned on, and FIG. 22B shows a current path when the first lower switch Q5 (35) of the first leg 3 is turned off.

Referring to FIG. 22A, under a normal condition, a current path through the inductor 15—Q5 (35)—the anti-parallel diode of Q6 (36) occurs, and in this case, power is charged in the inductor 15. In FIG. 22B, where Q5 (35) is turned off, a current path through the inductor 15—D3 (43)—the DC link capacitor 40—the anti-parallel diode of Q6 (36) is formed, and thus, the semi-bridgeless power conversion device 2000_3 operates in a voltage boosting mode. Therefore, according to FIGS. 18A and 18B, a current path is formed in a normal condition of Period 3, and thus, a period in which current becomes 0 may be minimized.

Table 1 below summarizes the switches operating in Periods 2 and 3 in the unidirectional totem pole power conversion device 2000_1, the bidirectional totem pole power conversion device 2000_2, and the semi-bridgeless power conversion device 2000_3 according to an embodiment of the disclosure.

TABLE 1

| | | | Operation switch | | | |
|---|---|---|---|---|---|---|
| | | | | Bidirectional | Bidirectional | |
| | | | Unidirectional | Totem pole | Totem pole | Semi- |
| | | | Totem pole | Power | Power | bridgeless |
| | Sensing | Actual | Power | conversion | conversion | power |
| | Input | Input | conversion | Device | Device | conversion |
| | voltage | voltage | Device | First leg | Second leg | device |
| Period 2 | − | + (Abnormal) | Q1 (31) | Q1 (31) | Q4 (34) | Q6 (36) |
| | | − (Normal) | | | | |
| Period 3 | + | − (Abnormal) | Q2 (32) | Q2 (32) | Q3 (33) | Q5 (35) |
| | | + (Normal) | | | | |

As shown in Table 1, the switch that operates is the same when a period is set, whether the condition is an abnormal condition or a normal condition, and the only difference is that actual current does not flow in a circuit when the condition is abnormal and current flows when the condition is normal.

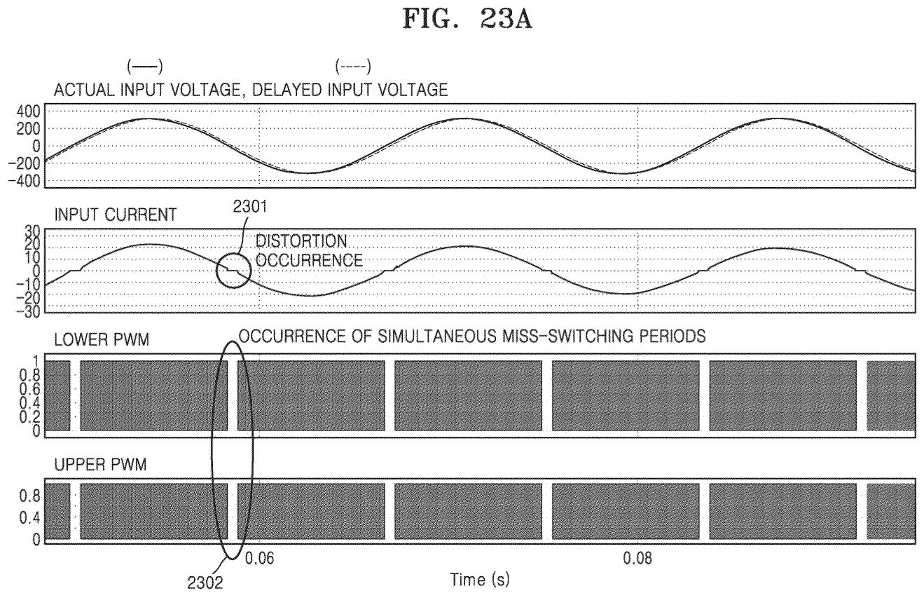

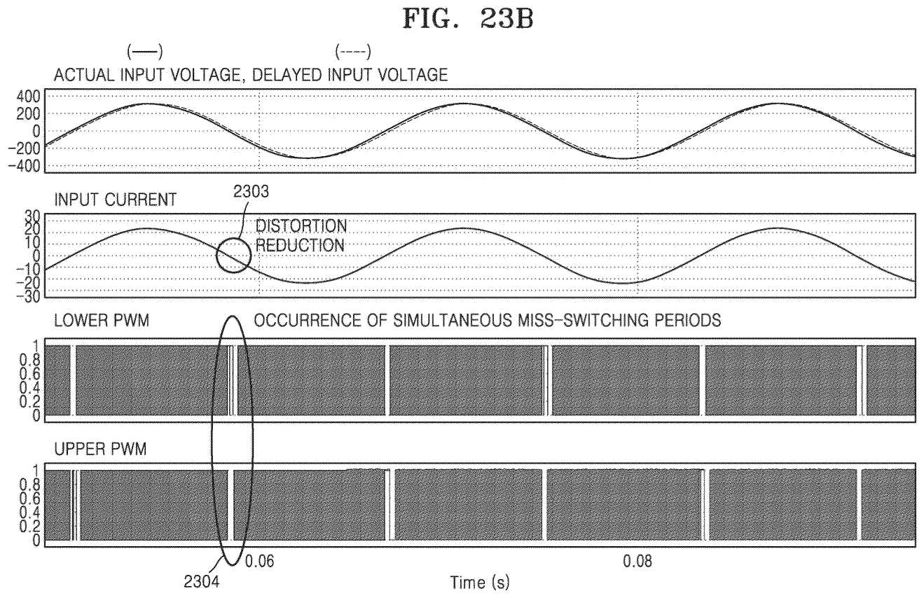

FIG. 23A is a waveform diagram illustrating an input voltage and an input current when a non-switching period is set at zero crossing, according to an embodiment of the disclosure.

Referring to FIG. 23A, at the top thereof, the actual voltage of the input voltage supplier 10 is displayed as a solid line at the top, and the delayed input voltage is displayed as a dotted line. The bridgeless PFC power conversion device 1000 sets a non-switching period 2302 simultaneously to the first upper switch Q1 (31) and the first lower switch Q2 (32) at zero crossing due to a phase difference between the actual voltage of the input voltage supplier 10 and the input voltage delayed by a delay element In this way, when a non-switching period 1902 is set simultaneously for the first upper switch Q1 (31) and the second lower switch Q2 (32) at zero crossing, distortion 2301 occurs near the zero crossing as shown in the input current waveform. The distortion 2301 of the input current may result in increased harmonics and is not good for the life of the device.

FIG. 23B is a waveform diagram illustrating an input voltage and an input current when only one switch is switched per period at zero crossing, according to an embodiment of the disclosure.

FIG. 23B shows the waveforms of the input voltage and input current when only one switch is switched in a specific leg per period (Period 2 or Period 3) at zero crossing in the power conversion device 2000 according to an embodiment of the disclosure.

According to an embodiment, in Period 2 where the sensed input voltage approaches zero from negative (−), only one switch of one leg of the power conversion device 2000 may perform an on-off operation, and in Period 3 where the sensed input voltage rises from zero to positive (+), only one switch of one leg of the power conversion device 2000 may perform an on-off operation.

In this way, when only one switch operates in Period 2 or Period 3, distortion is reduced (2303) near the zero crossing of the actual voltage of the input voltage supplier 10 as shown in FIG. 23B. This is because the non-switching period disappears near the zero crossing and the voltage boosting mode occurs by switching (2304) only one switch of the power conversion device 2000, causing current flow in the power conversion device 2000.

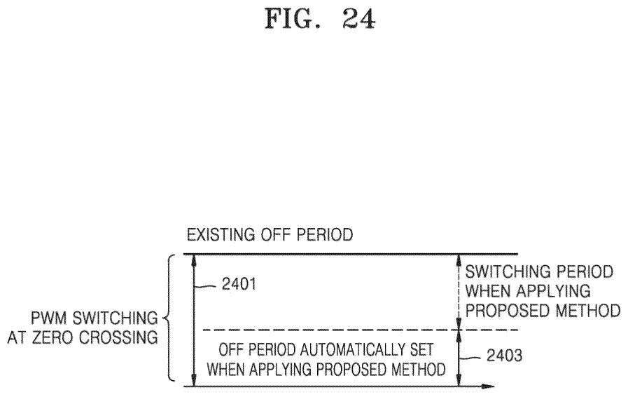

FIG. 24 is a diagram showing the size of a PWM switching period at zero crossing of an input voltage of a power conversion device, according to an embodiment of the disclosure.

According to FIG. 24, the size of a period in which PWM switching is not performed at a conventional zero crossing in the power conversion device 2000 is marked as 2401. However, because a period, in which only one switch of the power conversion device 2000 switches at a zero crossing in Periods 2 and 3 according to an embodiment of the disclosure, the non-switching period is reduced, and when the method proposed in the disclosure is applied, the period in which actual PWM switching does not occur is reduced to the size of 2403.

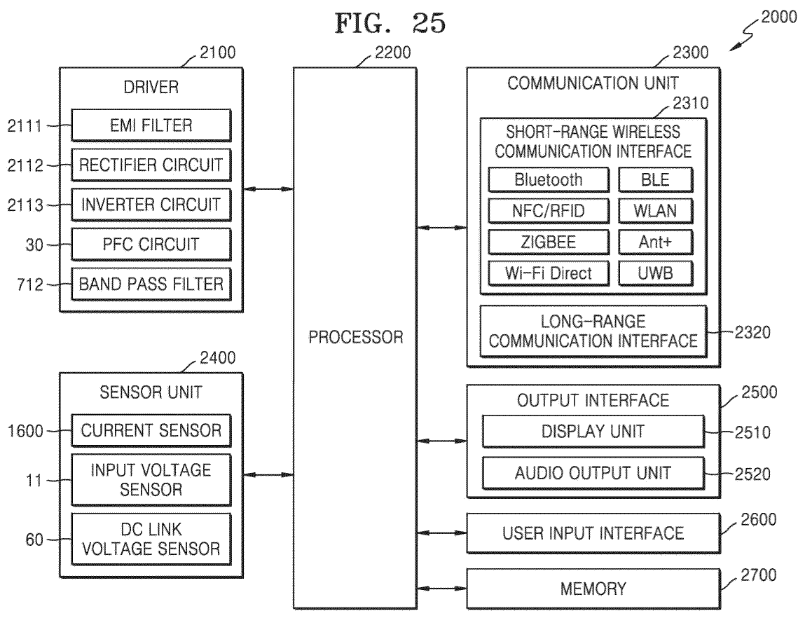

FIG. 25 is a block diagram of a power conversion device according to an embodiment of the disclosure.

A power conversion device 2000 according to the block diagram of FIG. 25 may include all of the unidirectional totem pole bridgeless PFC power conversion device 2000_1 of FIG. 4A, the bidirectional totem pole bridgeless PFC power conversion device 2000_2 of FIG. 4B, and the semi-bridgeless PFC power conversion device 2000_3 of FIG. 4C. The block diagram of the power conversion device 2000 of FIG. 25 may include a microcomputer or a processor 2200 that performs gate control of the PFC circuit 30 and overall control of the power conversion device 2000 together with a circuit diagram according to the system.

As illustrated in FIG. 25, the power conversion device 2000 according to an embodiment of the disclosure may include a driver 2100, a processor 2200, a communication unit 2300, a sensor unit 2400, an output interface 2500, a user input interface 2600, and a memory 2700. Not all of the components of the power conversion device 2000 are essential, and each of the components may be added or subtracted depending on the design concept of the manufacturer. For example, the power conversion device 2000 according to an embodiment of the disclosure may not include at least a portion of the communication unit 2300, and may not include at least a portion of the driver 2100, the sensor unit 2400, the output interface 2500, and/or the user input interface 2600.

Hereinafter, the above components will be described in sequence.

The driver 2100 may receive power from an external power supply and supply a current to the load according to a driving control signal of the processor 2200. The driver 2100 may include an electromagnetic interference (EMI) filter 2111, a rectifier circuit 2112, an inverter circuit 2113, a PFC circuit 30, and a band pass filter 712; however, the disclosure is not limited thereto.

The EMI filter 2111 may block a high-frequency noise included in alternating current (AC) power supplied from an external power supply (external source (ES)) and pass an AC voltage and an AC current of a predetermined frequency (e.g., 50 Hz or 60 Hz). A fuse and a relay for blocking an overcurrent may be arranged between the EMI filter 2111 and the external power supply (ES). The AC power obtained when the high-frequency noise is blocked by the EMI filter 2111 may be supplied to the rectifier circuit 2112.

The rectifier circuit 2112 may be a circuit included in the rectifier 20. The rectifier circuit 2112 may convert AC power into DC power. For example, the rectifier circuit 2112 may convert an AC voltage (positive voltage or negative voltage) whose magnitude and polarity change with time into a DC voltage whose magnitude and polarity are constant and may convert an AC current (positive current or negative current) whose magnitude and direction change with time into a DC current whose magnitude is constant. However, when the power conversion device 2000 according to an embodiment of the disclosure is configured with a totem pole topology, the rectifier circuit 2112 may not be configured separately but may be included in the inverter circuit 2113. Therefore, the rectifier circuit 2112 may be configured as a circuit that includes some switches, rather than a bridge structure that is configured only with pure diodes by a bridgeless structure in the power conversion device 2000 according to an embodiment of the disclosure. For example, the rectifier circuit 2112 may include four diodes, and the diodes may be anti-parallel diodes included in switches. The diode may convert an AC voltage whose polarity changes with time into a positive voltage whose polarity is constant and may convert an AC current whose direction changes with time into a positive current whose direction is constant. In another embodiment, the rectifier circuit 2112 may include two diodes and two switches. In an embodiment, a switch and a diode may constitute a rectifier leg, and another switch and another diode may constitute another rectifier leg. In an embodiment, the rectifier circuit 2112 may include one leg including two switches and one leg including two diodes. In an embodiment, the rectifier circuit 2112 may include two legs including two switches. However, this corresponds to the case where the input power is single-phase, and when the input power is three-phase, the rectifier circuit 2112 may include three legs including three switches and three diodes. The processor 2200 may control the switches such that the voltage charged into the DC link capacitor 40 does not increase abruptly but increases gradually. The switch may be composed of, but is not limited to, a transistor, a thyristor, an IGBT, a MOSFET, a GTO, etc.

The inverter circuit 2113 may be omitted in the power conversion device 2000 according to an embodiment of the disclosure. The inverter circuit 2113 may include a switching circuit that supplies or blocks a current to a load (not illustrated). The switching circuit may include a first switch and a second switch. The first switch and the second switch may be connected in series between a plus line and a minus line output from the rectifier circuit 2112. The first switch and the second switch may be turned on or off according to a driving control signal of the processor 2200.

The inverter circuit 2113 may control a current supplied to the load. For example, the magnitude and direction of a current flowing through the load may change according to the turn-on/off of the first switch and the second switch included in the inverter circuit 2113. In this case, an AC current may be supplied to the load. An AC current in the form of a sine wave may be supplied to the load according to the switching operation of the first switch and the second switch. Also, as the switching cycle of the first switch and the second switch increases (e.g., as the switching frequency of the first switch and the second switch decreases), the current supplied to the load may increase, and because the inverter circuit 2113 may be required to supply an alternating current to the load, the inverter circuit 2113 may not be required in the power conversion device 2000 that supplies a direct current to the load.

The driver 2100 of the power conversion device 2000 may include a band pass filter 712. The band pass filter 712 may be configured as an analog circuit or may also be implemented as a digital program. The band pass filter 712 may be a low-pass filter in the power conversion device 2000 according to an embodiment of the disclosure.

The processor 2200 may control an overall operation of the power conversion device 2000. By executing the programs stored in the memory 2700, the processor 2200 may control the driver 2100, the communication unit 2300, the sensor unit 2400, the output interface 2500, the user input interface 2600, and the memory 2700.

According to an embodiment of the disclosure, the processor 2200 may be mounted with an artificial intelligence (AI) processor. The AI processor may be manufactured in the form of a dedicated hardware chip for AI and may be manufactured as a portion of a general-purpose processor (e.g., CPU or application processor) or a dedicated graphics processor (e.g., GPU) and then mounted on the heating device 2000.

According to an embodiment of the disclosure, the processor 2200 may perform the controller operation of a voltage controller 101, a current controller 103, and a PWM generator 105 included in the power conversion device 2000. Here, the controllers, such as the current controller and the voltage controller, may be PI controllers; however, the disclosure is not limited thereto. In addition, according to an embodiment of the disclosure, the processor 2200 may perform operations of the phase estimator 120, the zero crossing detector 150, and the PWM controller 170 included in the power conversion device 2000.

The processor 2200 may include the communication unit 2300 to operate on an Internet of Things (IoT) network or a home network as necessary.

The communication unit 2300 may include a short-range wireless communication interface 2310 and a long-range communication interface 2320. The short-range wireless communication interface 2310 may include, but is not limited to, a Bluetooth communication interface, a Bluetooth Low Energy (BLE) communication interface, a Near Field Communication interface, a WLAN (WiFi) communication interface, a ZigBee communication interface, an Infrared Data Association (IrDA) communication interface, a WiFi Direct (WFD) communication interface, an Ultra-Wideband (UWB) communication interface, and/or an Ant+ communication interface. The long-range communication interface 2320 may transmit/receive wireless signals to/from at least one of a base station, an external terminal, or a server on a mobile communication network. Here, the wireless signals may include voice call signals, video call signals, or various types of data according to transmission/reception of text/multimedia messages. The long-range communication interface 2320 may include a 3G module, a 4G module, a 5G module, an LTE module, an NB-IoT module, and/or an LTE-M module but is not limited thereto.

According to an embodiment of the disclosure, through the communication unit 2300, communication may be performed with and data may be transmitted/received to/from a server or other electric appliances outside the power conversion device 2000.

The sensor unit 2400 may include a current sensor 1600 and a DC link voltage sensor 60. According to an embodiment of the disclosure, an input voltage sensor 11 may sense an voltage of the input voltage supplier 10. The current sensor 1600 may be arranged at various positions in the circuit of the power conversion device 2000 to obtain current (mainly AC current) information. A DC link voltage sensor 60 may sense a DC link voltage to be used as an input of the voltage controller 101.

The output interface 2500 may be for outputting an audio signal or a video signal and may include a display unit 2510 and an audio output unit 2520.

According to an embodiment of the disclosure, the power conversion device 2000 may display information related to the power conversion device 2000 through the display unit 2510. For example, the power conversion device 2000 may display, on the display unit 2510, information on the operation mode of the power conversion device 2000, whether the power conversion device 2000 is operating in any of the periods (Period 1 to Period 4) shown in FIG. 6B, power factor information of the power conversion device 2000, or each harmonic component value (e.g., % or A (ampere) of each harmonic component versus the input current). According to FIG. 6B, whether the power conversion device 2000 is operating in any of the periods (Period 1 to Period 4) may be indicated based on the sign (+, −) of the input voltage sensed by the input voltage sensor 11.

When the display unit 2510 and a touch pad are configured as a touch screen by forming a layer structure, the display unit 2510 may also be used as an input device in addition to an output device. The display unit 2510 may include at least one of a liquid crystal display, a thin film transistor-liquid crystal display, a light emitting diode (LED), an organic light emitting diode, a flexible display, a three-dimensional (3D) display, or an electrophoretic display. Also, depending on the type of the power conversion device 2000, the power conversion device 2000 may include two or more display units 2510.

The audio output unit 2520 may output audio data received from the communication unit 2300 or stored in the memory 2700. Also, the audio output unit 2520 may output an audio signal related to a function performed by the power conversion device 2000. The audio output unit 2520 may include a speaker and/or a buzzer.

According to an embodiment of the disclosure, the output interface 2500 may output at least one of the operation mode information, the power factor information, and the harmonic component information through the display unit 2510. According to an embodiment of the disclosure, the output interface 2500 may display a current power level, an operation mode (e.g., a low-noise mode, a normal mode, or a high-power mode during PFC control), a power factor control state, a current power factor, and/or the like.

The user input interface 2600 may be for receiving an input from the user. The user input interface 2600 may include, but is not limited to, at least one of a keypad, a dome switch, a touch pad (e.g., a capacitive overlay type, a resistive overlay type, an infrared beam type, a surface acoustic wave type, an integral strain gauge type, or a piezoelectric type), a jog wheel, or a jog switch.

The user input interface 2600 may include a speech recognition module. For example, the power conversion device 2000 may receive a voice signal, which is an analog signal, through a microphone and convert a voice portion into computer-readable text by using an automatic speech recognition (ASR) model. By using a natural language understanding (NLU) model, the power conversion device 2000 may interpret the resulting text to obtain the intention of the user's utterance. Here, the ASR model or the NLU model may be an AI model. The AI model may be processed by a dedicated AI processor designed in a hardware structure specialized for processing the AI model. The AI model may be generated through training. Here, being generated through training may mean that a basic AI model is trained by a learning algorithm by using a plurality of pieces of training data and accordingly a predefined operation rule or AI model set to perform a desired feature (or purpose) is generated. The AI model may include a plurality of neural network layers. Each of the plurality of neural network layers may have a plurality of weights (weight values) and may perform a neural network operation through an operation between the plurality of weights and the operation result of a previous layer.

Linguistic understanding may be a technology for recognizing and applying/processing human languages/characters and may include natural language processing, machine translation, dialog system, question answering, speech recognition/synthesis, and the like.

The memory 2700 may store a program for processing and controlling by the processor 2200 and may store input/output data (e.g., an operation mode of the power conversion device 2000, power factor information of the power conversion device 2000, or information about the harmonic component). The memory 2700 may store an AI model.

The memory 2700 may include at least one type of storage medium from among flash memory type, hard disk type, multimedia card micro type, card type memory (e.g., SD or XD memory), random access memory (RAM), static random access memory (SRAM), read only memory (ROM), electronically erasable programmable read only memory (EEPROM), programmable read only memory (PROM), magnetic memory, magnetic disk, and optical disk. Also, the power conversion device 2000 may operate a cloud server or a web storage for performing a storage function on the Internet.

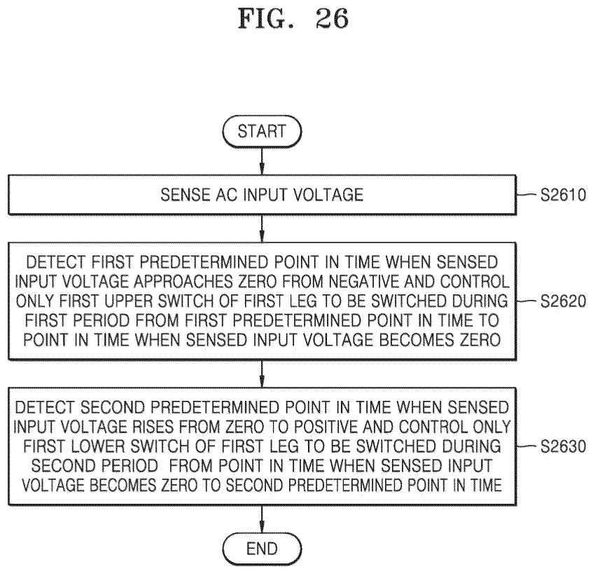

FIG. 26 is a flowchart of switching control at zero crossing of an input voltage in a power conversion device according to an embodiment of the disclosure.

The power conversion device 2000 according to FIG. 26 may be the unidirectional totem pole power conversion device 2000_1 or the bidirectional totem pole power conversion device 2000_2.

In operation S2610, the input voltage sensor 11 of the power conversion device 2000 senses an AC voltage of the input voltage supplier 10.

In operation S2620, according to an embodiment, the processor 2200 of the power conversion device 2000 may determine a first predetermined point in time when the sensed input voltage approaches zero from a negative (−) value, and may control only the first upper switch Q1 (31) of the first leg 1 of the power conversion device 2000 to be switched during a first period (corresponding to Period 2 of FIG. 6B) from the determined first predetermined point in time to a point in time when the sensed input voltage becomes zero. The first predetermined point in time is a point at which the sensed input voltage approaches zero and has a negative (−) value, and the first predetermined point in time may be determined experimentally, or may be determined as a point, at which the input voltage becomes a percentage (e.g., 2%) of a maximum value, by considering noise and the like.

In operation S2630, according to an embodiment, the processor 2200 of the power conversion device 2000 detects a second predetermined point in time, at which the sensed input voltage is close to zero and is positive (+), when the sensed input voltage rises from zero to positive (+). The processor 2200 may control only the first lower switch Q2 (32) of the first leg 1 of the power conversion device 2000 to be switched during a second period (corresponding to Period 3 of FIG. 6B) from a point in time when the sensed input voltage becomes zero to the second predetermined point in time. The second predetermined point in time may be determined experimentally, or may be determined as a point, at which the input voltage becomes a percentage (e.g., 2%) of a maximum value, by considering noise and the like.

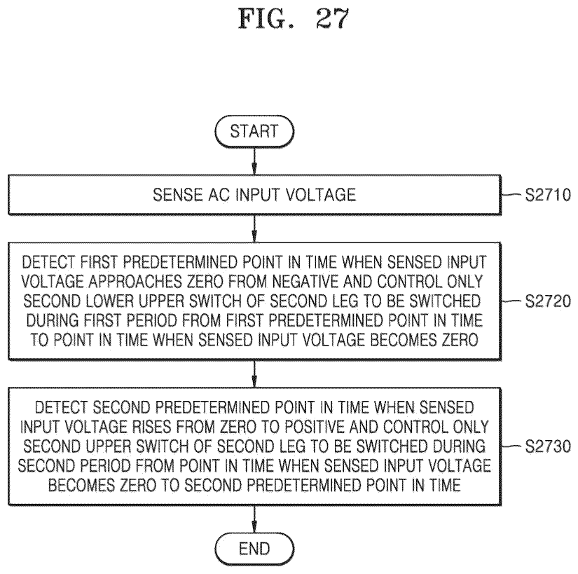

FIG. 27 is a flowchart of switching control at zero crossing of an input voltage in a power conversion device according to an embodiment of the disclosure.

Referring to FIG. 27, the power conversion device 2000 may be the bidirectional totem pole power conversion device 2000_2, and the switches of the second leg 2 in the bidirectional totem pole power conversion device 2000_2 may operate.

In operation S2710, the input voltage sensor 11 of the power conversion device 2000 senses an AC voltage of the input voltage supplier 10.

In operation S2720, according to an embodiment, the processor 2200 of the power conversion device 2000 may determine a first predetermined point in time when the sensed input voltage approaches zero from a negative (−) value, and may control only the second lower switch Q4 (34) of the second leg 2 of the power conversion device 2000 to be switched during a first period (corresponding to Period 2 of FIG. 6B) from the determined first predetermined point in time to a point in time when the sensed input voltage becomes zero. The first predetermined point in time is a point at which the sensed input voltage approaches zero and has a negative (−) value, and the first predetermined point in time may be determined experimentally, or may be determined as a point, at which the input voltage becomes a percentage (e.g., 2%) of a maximum value, by considering noise and the like.

In operation S2730, according to an embodiment, the processor 2200 of the power conversion device 2000 detects a second predetermined point in time, at which the sensed input voltage is close to zero and is positive (+), when the sensed input voltage rises from zero to positive (+). The processor 2200 may control only the second upper switch Q5 (35) of the second leg 2 of the power conversion device 2000 to be switched during a second period (corresponding to Period 3 of FIG. 6B) from a point in time when the sensed input voltage becomes zero to the second predetermined point in time. The second predetermined point in time may be determined experimentally, or may be determined as a point, at which the input voltage becomes a percentage (e.g., 2%) of a maximum value, by considering noise and the like.

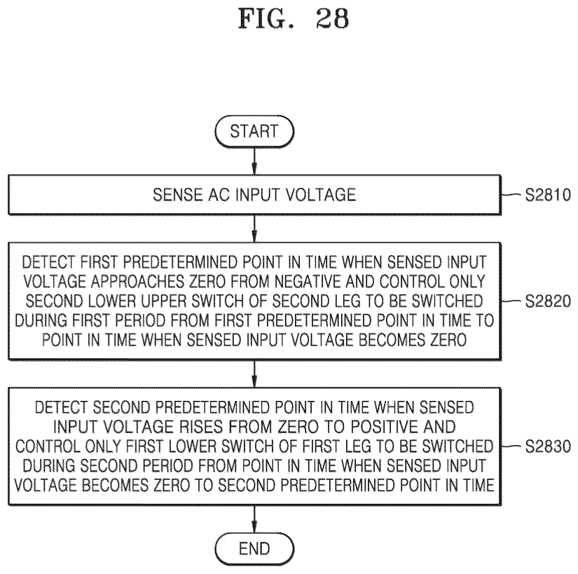

FIG. 28 is a flowchart of switching control at zero crossing of an input voltage in a power conversion device according to an embodiment of the disclosure.

Referring to FIG. 28, the power conversion device 2000 may be the semi-bridgeless power conversion device 2000_3.

In operation S2810, the input voltage sensor 11 of the power conversion device 2000 senses an AC voltage of the input voltage supplier 10.

In operation S2820, according to an embodiment, the processor 2200 of the power conversion device 2000 may determine a first predetermined point in time when the sensed input voltage approaches zero from a negative (−) value, and may control only the second lower switch Q6 (36) of the second leg 4 of the power conversion device 2000 to be switched during a first period (corresponding to Period 2 of FIG. 6B) from the determined first predetermined point in time to a point in time when the sensed input voltage becomes zero. The first predetermined point in time is a point at which the sensed input voltage approaches zero and has a negative (−) value, and the first predetermined point in time may be determined experimentally, or may be determined as a point, at which the input voltage becomes a percentage (e.g., 2%) of a maximum value, by considering noise and the like.

In operation S2830, according to an embodiment, the processor 2200 of the power conversion device 2000 detects a second predetermined point in time, at which the sensed input voltage is close to zero and is positive (+), when the sensed input voltage rises from zero to positive (+). The processor 2200 may control only the first lower switch Q5 (35) of the first leg 3 of the power conversion device 2000 to be switched during a second period (corresponding to Period 3 of FIG. 6B) from a point in time when the sensed input voltage becomes zero to the second predetermined point in time. The second predetermined point in time may be determined experimentally, or may be determined as a point, at which the input voltage becomes a percentage (e.g., 2%) of a maximum value, by considering noise and the like.

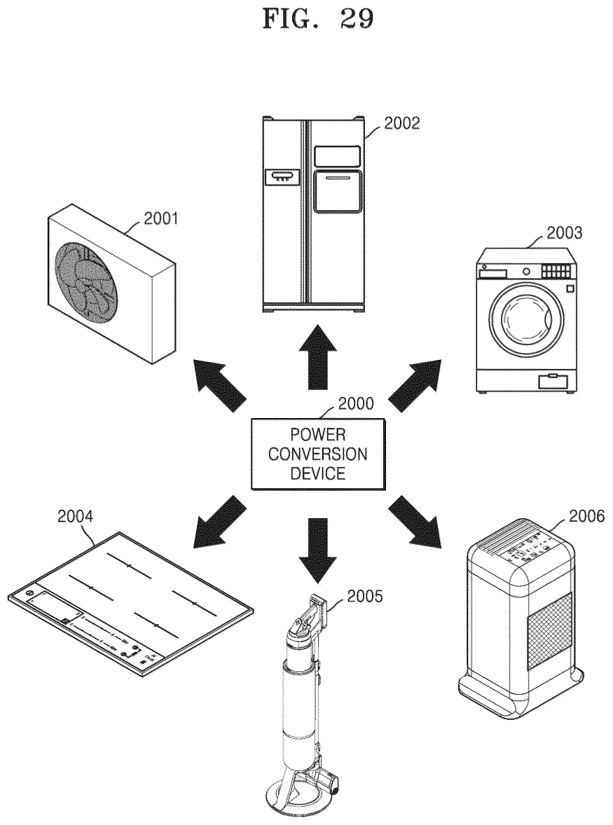

FIG. 29 is a diagram illustrating various household appliances including a power conversion device according to an embodiment of the disclosure.

Referring to FIG. 29, a power conversion device 2000 according to an embodiment of the disclosure may be applied to and included in various household appliances.

According to an embodiment, the power conversion device 2000 may be used in an air conditioner 2001. The air conditioner 2001 may include an outdoor unit and an indoor unit, and the power conversion device 2000 may be used in either the outdoor unit or the indoor unit.

In addition, the power conversion device 2000 according to an embodiment of the disclosure may be used in a refrigerator 2002. In an embodiment, the power conversion device 2000 according to an embodiment of the disclosure may be used in a compressor of a refrigerator 2002. In addition, the power conversion device 2000 according to an embodiment of the disclosure may be used in a washing machine 2003, a cooking appliance 2004, a vacuum cleaner 2005, and an air purifier 2006 that drive a motor.

A household appliance including a power conversion device for PWM switching of an input voltage, according to an embodiment of the disclosure, may include an input voltage sensor configured to sense an input voltage. The household appliance including a power conversion device for PWM switching of an input voltage, according to an embodiment, may include a first leg including a first upper switch and a first lower switch. The household appliance including a power conversion device for PWM switching of an input voltage, according to an embodiment, may include at least one processor configured to detect a first predetermined point in time when the input voltage sensed by the input voltage sensor approaches zero from negative and control only the first upper switch to be switched during a first period from the first predetermined point in time to a point in time when the sensed input voltage becomes zero. The household appliance including a power conversion device for PWM switching of an input voltage, according to an embodiment, may include at least one processor configured to detect a second predetermined point in time when the input voltage sensed by the input voltage sensor rises from zero to positive and control only the first lower switch to be switched during a second period from the point in time when the sensed input voltage becomes zero to the second predetermined point in time.

According to an embodiment, the at least one processor may be further configured to decrease an on-duty ratio of the first upper switch as the sensed input voltage approaches zero during the first period.

According to an embodiment, the at least one processor may be further configured to increase an on-duty ratio of the first lower switch as the sensed input voltage approaches the second predetermined point in time during the second period.

According to an embodiment, the household appliance may further include a diode leg including an upper diode and a lower diode, and the power conversion device may be a unidirectional totem pole power conversion device.

According to an embodiment, the household appliance may further include a second leg including a second upper switch and a second lower switch, and the power conversion device may be a bidirectional totem pole power conversion device.

According to an embodiment, switching speeds of the first upper switch and the first lower switch of the first leg may be relatively faster than switching speeds of the second upper switch and the second lower switch of the second leg.

A method for PWM switching of an input voltage, according to an embodiment of the disclosure, as a method of switching an input voltage in a household appliance including an input voltage sensor and a first leg including a first upper switch and a first lower switch, may include sensing, by the input voltage sensor, an input voltage. The method for PWM switching of an input voltage, according to an embodiment, may include detecting a first predetermined point in time when the input voltage sensed by the input voltage sensor approaches zero from negative. The method for PWM switching of an input voltage, according to an embodiment, may include controlling only the first upper switch to be switched during a first period from the first predetermined point in time to a point in time when the sensed input voltage becomes zero. The method for PWM switching of an input voltage, according to an embodiment, may include detecting a second predetermined point in time when the sensed input voltage rises from zero to positive and controlling only the first lower switch to be switched during a second period from the point in time when the sensed input voltage becomes zero to the second predetermined point in time.

According to an embodiment, the controlling of only the first upper switch of the first leg to be switched during the first period from the first predetermined point in time to the point in time when the sensed input voltage becomes zero may include decreasing an on-duty ratio of the first upper switch as the sensed input voltage approaches zero during the first period.

According to an embodiment, the detecting of the second predetermined point in time when the sensed input voltage rises from zero to positive and the controlling of only the first lower switch of the first leg to be switched during the second period from the point in time when the sensed input voltage becomes zero to the second predetermined point in time may include increasing the on-duty ratio of the first lower switch as the sensed input voltage approaches the second predetermined point in time during the second period.

According to an embodiment, the household appliance may further include a second leg including a second upper switch and a second lower switch, and the household appliance may include a unidirectional totem pole power conversion device.

According to an embodiment, the household appliance may further include a second leg including a second upper switch and a second lower switch, and the household appliance may include a bidirectional totem pole power conversion device.

According to an embodiment, switching speeds of the first upper switch and the first lower switch of the first leg may be relatively faster than switching speeds of the second upper switch and the second lower switch of the second leg.

A power conversion device for performing PWM switching of an input voltage, according to an embodiment of the disclosure, may include an input voltage sensor configured to sense an input voltage. The power conversion device for performing PWM switching of an input voltage, according to an embodiment of the disclosure, may include a first leg including a first upper switch and a first lower switch. The power conversion device for performing PWM switching of an input voltage, according to an embodiment of the disclosure, may include at least one processor configured to detect a first predetermined point in time when the input voltage sensed by the input voltage sensor approaches zero from negative and control only the first upper switch to be switched during a first period from the first predetermined point in time to a point in time when the sensed input voltage becomes zero. The power conversion device for performing PWM switching of an input voltage, according to an embodiment of the disclosure, may include at least one processor configured to detect a second predetermined point in time when the input voltage sensed by the input voltage sensor rises from zero to positive and control only the first lower switch to be switched during a second period from the point in time when the sensed input voltage becomes zero to the second predetermined point in time.

According to an embodiment, the at least one processor may be further configured to decrease an on-duty ratio of the first upper switch as the sensed input voltage approaches zero during the first period.

According to an embodiment, the at least one processor may be further configured to increase an on-duty ratio of the first lower switch as the sensed input voltage approaches the second predetermined point in time during the second period.

According to an embodiment, the household appliance may further include a diode leg including an upper diode and a lower diode, and the power conversion device may be a unidirectional totem pole power conversion device.

According to an embodiment, the household appliance may further include a second leg including a second upper switch and a second lower switch, and the power conversion device may be a bidirectional totem pole power conversion device.

According to an embodiment, switching speeds of the first upper switch and the first lower switch of the first leg may be relatively faster than switching speeds of the second upper switch and the second lower switch of the second leg.

A household appliance according to an embodiment of the disclosure may include an input voltage sensor configured to sense an input voltage, a first leg including a first upper switch and a first lower switch, a second leg including a second upper switch and a second lower switch, and a power conversion device including at least one processor configured to detect a first predetermined point in time when the input voltage sensed by the input voltage sensor approaches zero from negative and control only the second lower switch to be switched during a first period from the first predetermined point in time to a point in time when the sensed input voltage becomes zero, and to detect a second predetermined point in time when the input voltage sensed by the input voltage sensor rises from zero to positive and control only the second upper switch to be switched during a second period from the point in time when the sensed input voltage becomes zero to the second predetermined point in time

According to an embodiment, the at least one processor may be further configured to decrease an on-duty ratio of the second lower switch as the sensed input voltage approaches zero during the first period.

According to an embodiment, the at least one processor may be further configured to increase an on-duty ratio of the second upper switch as the sensed input voltage approaches the second predetermined point in time during the second period.

According to an embodiment, the household appliance may include a bidirectional totem pole power conversion device.

According to an embodiment, switching speeds of the second upper switch and the second lower switch of the second leg may be relatively faster than switching speeds of the first upper switch and the first lower switch of the first leg.

A household appliance according to an embodiment of the disclosure may include an input voltage sensor configured to sense an input voltage, a first leg including a first upper diode and a first lower switch, a second leg including a second upper diode and a second lower switch, and a power conversion device including at least one processor configured to detect a first predetermined point in time when the input voltage sensed by the input voltage sensor approaches zero from negative and control only the second lower switch to be switched during a first period from the first predetermined point in time to a point in time when the sensed input voltage becomes zero, and to detect a second predetermined point in time when the input voltage sensed by the input voltage sensor rises from zero to positive and control only the first lower switch to be switched during a second period from the point in time when the sensed input voltage becomes zero to the second predetermined point in time

According to an embodiment, the at least one processor may be further configured to decrease an on-duty ratio of the second lower switch as the sensed input voltage approaches zero during the first period.

According to an embodiment, the at least one processor may be further configured to increase an on-duty ratio of the first lower switch as the sensed input voltage approaches the second predetermined point in time during the second period.

According to an embodiment, the household appliance may include a semi-bridgeless power conversion device.

Not all of the components illustrated in the power conversion device 2000 according to an embodiment of the disclosure are essential components. The power conversion device 2000 may be implemented with more components than the illustrated components, or may be implemented with fewer components than the illustrated components. Throughout the specification, the power conversion device 2000 may be referred to as a household appliance, a home appliance, a cooking appliance, or an electrical device, and these terms may be used interchangeably or substituted. Also, throughout the specification, an electrical device including the power conversion device 2000 may be a household appliance sold independently, or may be a device that constitutes a part of a household appliance.

An embodiment of the disclosure may also be implemented in the form of computer-readable recording mediums including instructions executable by computers, such as program modules executed by computers. The computer-readable recording mediums may be any available mediums accessible by computers and may include both volatile and non-volatile mediums and detachable and non-detachable mediums. Also, the computer-readable recording mediums may include computer storage mediums and communication mediums. The computer storage mediums may include both volatile and non-volatile and detachable and non-detachable mediums implemented by any method or technology for storage of information such as computer-readable instructions, data structures, program modules, or other data. The communication mediums may include any information transmission medium and may include other transmission mechanisms or other data of modulated data signals such as computer-readable instructions, data structures, program modules, or carriers. Also, an embodiment of the disclosure may be implemented as computer programs or computer program products including instructions executable by computers, such as computer programs executed by computers.

The machine-readable storage medium may be provided in the form of a non-transitory storage medium. Here, the term “non-transitory storage medium” may mean that the storage medium is a tangible device and does not include signals (e.g., electromagnetic waves), and may mean that data may be semipermanently or temporarily stored in the storage medium. For example, the “non-transitory storage medium” may include a buffer in which data is temporarily stored.

According to an embodiment, the method according to an embodiment of the disclosure may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user devices (e.g., smartphones). In the case of online distribution, at least a portion of the computer program product (e.g., a downloadable app) may be at least temporarily stored or temporarily generated in a machine-readable storage medium such as a memory of a manufacturer server, a memory of an application store server, or a memory of a relay server.

What is claimed is:

1. An appliance comprising:
a power conversion device comprising:
an input voltage sensor configured to sense an input voltage;
a first leg comprising a first upper switch and a first lower switch;
memory storing instructions; and
at least one processor,
wherein the instructions, when executed by the at least one processor, cause the power conversion device to:
detect a first predetermined point in time at which the input voltage sensed by the input voltage sensor approaches zero from negative,
control only the first upper switch to be switched during a first period from the first predetermined point in time to a point in time at which the sensed input voltage reaches zero,
detect a second predetermined point in time at which the sensed input voltage sensed by the input voltage sensor rises from zero to positive, and
control only the first lower switch to be switched during a second period from the point in time at which the sensed input voltage reaches zero to the second predetermined point in time.

2. The appliance of claim 1, wherein the instructions, when executed by the at least one processor, cause the power conversion device to decrease an on-duty ratio of the first upper switch as the sensed input voltage approaches zero during the first period.

3. The appliance of claim 1, wherein the instructions, when executed by the at least one processor, cause the power conversion device to increase an on-duty ratio of the first lower switch as the sensed input voltage approaches the second predetermined point in time during the second period.

4. The appliance of claim 1, further comprising a diode leg comprising an upper diode and a lower diode,
wherein the power conversion device is a unidirectional totem pole power conversion device.

5. The appliance of claim 1, further comprising a second leg comprising a second upper switch and a second lower switch,
wherein the power conversion device is a bidirectional totem pole power conversion device.

6. The appliance of claim 5, wherein switching speeds of the first upper switch and the first lower switch of the first leg are faster than switching speeds of the second upper switch and the second lower switch of the second leg.

7. A method of switching an input voltage, in an appliance comprising an input voltage sensor, and a first leg comprising a first upper switch and a first lower switch, the method comprising:
sensing, by the input voltage sensor, the input voltage;
detecting a first predetermined point in time at which the input voltage sensed by the input voltage sensor approaches zero from negative;
controlling only the first upper switch to be switched during a first period from the first predetermined point in time to a point in time at which the sensed input voltage reaches zero;
detecting a second predetermined point in time at which the sensed input voltage rises from zero to positive; and
controlling only the first lower switch to be switched during a second period from the point in time at which the sensed input voltage reaches zero to the second predetermined point in time.

8. The method of claim 7, wherein the controlling only the first upper switch of the first leg to be switched during the first period from the first predetermined point in time to the point in time at which the sensed input voltage reaches zero comprises decreasing an on-duty ratio of the first upper switch as the sensed input voltage approaches zero during the first period.

9. The method of claim 7, wherein the detecting the second predetermined point in time at which the sensed input voltage rises from zero to positive and the controlling only the first lower switch of the first leg to be switched during the second period from the point in time at which the sensed input voltage reaches zero to the second predetermined point in time comprises increasing an on-duty ratio of the first lower switch as the sensed input voltage approaches the second predetermined point in time during the second period.

10. The method of claim 7, wherein the appliance further comprises:
a second leg comprising a second upper switch and a second lower switch; and
a unidirectional totem pole power conversion device.

11. The method of claim 7, wherein the appliance further comprises:
a second leg comprising a second upper switch and a second lower switch; and
a bidirectional totem pole power conversion device.

12. The method of claim 11, wherein switching speeds of the first upper switch and the first lower switch of the first leg are faster than switching speeds of the second upper switch and the second lower switch of the second leg.

13. A power conversion device comprising:
an input voltage sensor configured to sense an input voltage;
a first leg including a first upper switch and a first lower switch;
memory storing instructions; and
at least one processor,
wherein the instructions, when executed by the at least one processor, cause the power conversion device to:
detect a first predetermined point in time at which the input voltage sensed by the input voltage sensor approaches zero from negative;
control only the first upper switch to be switched during a first period from the first predetermined point in time to a point in time at which the sensed input voltage reaches zero;
detect a second predetermined point in time at which the input voltage sensed by the input voltage sensor rises from zero to positive; and
control only the first lower switch to be switched during a second period from the point in time at which the sensed input voltage reaches zero to the second predetermined point in time.

14. The power conversion device of claim 13, wherein the instructions, when executed by the at least one processor, cause the power conversion device to decrease an on-duty ratio of the first upper switch as the sensed input voltage approaches zero during the first period.

15. The power conversion device of claim 13, wherein the instructions, when executed by the at least one processor, cause the power conversion device to increase an on-duty ratio of the first lower switch as the sensed input voltage approaches the second predetermined point in time during the second period.

16. The power conversion device of claim 13, further comprising a diode leg comprising an upper diode and a lower diode,
wherein the power conversion device is a unidirectional totem pole power conversion device.

17. The power conversion device of claim 13, further comprising a second leg comprising a second upper switch and a second lower switch,
wherein the power conversion device is a bidirectional totem pole power conversion device.

18. The power conversion device of claim 17, wherein switching speeds of the first upper switch and the first lower switch of the first leg are faster than switching speeds of the second upper switch and the second lower switch of the second leg.
